(19) United States
(12) Patent Application Publication
(10) Pub. No.: US 2017/0293975 A1
(43) Pub. Date: Oct. 12, 2017

(54) ENERGY DEMAND-SUPPLY PLAN FORMULATION APPARATUS AND ENERGY DEMAND-SUPPLY PLAN FORMULATION PROGRAM

(71) Applicant: MITSUBISHI ELECTRIC CORPORATION, Tokyo (JP)

(72) Inventors: Yutaka SAITO, Tokyo (JP); Hiroyuki HASHIMOTO, Tokyo (JP); Shoichi KITAMURA, Tokyo (JP); Hideaki HIRANO, Tokyo (JP); Kotaro SANAI, Tokyo (JP)

(73) Assignee: MITSUBISHI ELECTRIC CORPORATION, Tokyo (JP)

(21) Appl. No.: 15/331,089

(22) Filed: Oct. 21, 2016

(30) Foreign Application Priority Data
Apr. 6, 2016 (JP) 2016-076298

(51) Int. Cl. G06Q 40/04; G05F 1/66; G06Q 50/06

(52) U.S. Cl. CPC G06Q 40/04; G06Q 50/06; G05F 1/66

(57) ABSTRACT

In an energy demand-supply plan formulation apparatus, the apparatus includes: a data coordination unit for calculating first coordination data including an electric power-generation unit-price and specific heat consumption from the electric power generation plan, for calculating second coordination data from the steam demand-supply plan, and for calculating third coordination data including an electric power generation fuel-consumption plan from the transaction plan and the electric power generation plan; a steam demand-supply planning unit for formulating a steam demand-supply plan by taking in first coordination data calculated by the data coordination unit; an electric power demand-supply planning unit for formulating a transaction plan in the electric power transaction market and an electric power generation plan therein by taking in second coordination data calculated by the data coordination unit; and a fuel demand-supply planning unit for formulating a fuel demand-supply plan by taking in third coordination data calculated by the data coordination unit.

### BACKGROUND OF THE INVENTION

### Field of the Invention

The present invention relates to an energy demand-supply plan formulation apparatus and an energy demand-supply plan formulation program which formulate an energy demand-supply plan targeting an electric power transaction market and a fuel transaction market, and in particular to an energy demand-supply plan formulation apparatus and an energy demand-supply plan formulation program which formulate an energy demand-supply plan including steam supply.

### Description of the Related Art

In an electric power transaction market and a fuel transaction market, a buy and a sell of electric power and fuel are regularly performed on a day-to-day basis. In the electric power transaction market and the fuel transaction market, an energy demand-supply plan including a transaction plan and an electric power generation plan is formulated. A portion of utility companies supplying electric power by using a thermal power generator extracts steam produced within the thermal power generator outside the power generator, and supplies the steam to a consumer (steam end-user) who needs it, so that profits are obtained. The utility company formulates a transaction plan in the electric power transaction market so that profits from electric power generation are maximized, and determines the amount of fuel consumption in line with the generation. Next, by obtaining the amount of fuel transaction to maximize profits from the fuel transaction while securing the amount of the fuel consumption, integrated planning assistance relating to each of energy transactions of electric power and fuel can be performed (for example, Patent Document 1).

### CITATION LIST

### Patent Literature

Patent Document 1: Japanese Patent Application Publication No. 2007-58760

### Problems to be Solved by the Invention

A portion of utility companies supplying electric power by using a thermal power generator extracts steam produced within the thermal power generator outside the power generator, and supplies the steam to a consumer (steam end-user) who needs it, so that profits are obtained. When steam supply is performed by using part of the steam that the thermal power generator uses as described above, the efficiency of the thermal power generator, namely, the amount of electric power generation changes with respect to the energy being put into. There exist tradeoffs between the amount of electric power generation and the costs such as fuel-consumption increase due to reductions in sales profits by the steam supply and in the efficiency of the thermal power generator, or cost increase due to electric power or electricity purchase costs with respect to output reduction. As a result, even when a demand-supply plan including an electric power transaction and a fuel transaction is formulated, there has been a case in which an acquired balance of accounts is reduced.

The present invention has been directed at solving those problems as described above, and an object of the invention is to formulate an energy demand-supply plan including an electric power transaction and a fuel transaction by performing mutual data coordination among an electric power demand-supply plan, a fuel demand-supply plan and a steam demand-supply plan, and to increase profits by considering changes in electric power generation efficiency of a thermal power generator according to its steam supply.

### SUMMARY OF THE INVENTION

### Means for Solving the Problems

In an energy demand-supply plan formulation apparatus according to the present invention which formulates a transaction plan in an electric power transaction market and an electric power generation plan therein, a steam demand-supply plan, and a fuel demand-supply plan, the energy demand-supply plan formulation apparatus comprises: a data coordination unit for calculating first coordination data including an electric power-generation unit-price and specific heat consumption from the electric power generation plan, for calculating second coordination data including an amount of fuel consumption from the steam demand-supply plan, and for calculating third coordination data including an electric power-generation fuel-consumption plan from the transaction plan and the electric power generation plan; a steam demand-supply planning unit for formulating a steam demand-supply plan by taking in first coordination data calculated by the data coordination unit; an electric power demand-supply planning unit for formulating a transaction plan in the electric power transaction market and an electric power generation plan therein by taking in second coordination data calculated by the data coordination unit; and a fuel demand-supply planning unit for formulating the fuel demand-supply plan by taking in third coordination data calculated by the data coordination unit.

### Effects of the Invention

In an energy demand-supply plan formulation apparatus according to the present invention which formulates a transaction plan in an electric power transaction market and an electric power generation plan therein, a steam demand-supply plan, and a fuel demand-supply plan, the energy demand-supply plan formulation apparatus comprises: a data coordination unit for calculating first coordination data including an electric power-generation unit-price and specific heat consumption from the electric power generation plan, for calculating second coordination data including an amount of fuel consumption from the steam demand-supply plan, and for calculating third coordination data including an electric power-generation fuel-consumption plan from the transaction plan and the electric power generation plan; a steam demand-supply planning unit for formulating a steam demand-supply plan by taking in first coordination data calculated by the data coordination unit; an electric power demand-supply planning unit for formulating a transaction plan in the electric power transaction market and an electric power generation plan therein by taking in second coordination data calculated by the data coordination unit; and a fuel demand-supply planning unit for formulating the fuel demand-supply plan by taking in third coordination data calculated by the data coordination unit, so that, by taking the configuration to perform mutual data coordination between the steam demand-supply planning unit and the electric power demand-supply planning unit, the energy demand-supply plan formulation apparatus achieves such effects that profits by steam supply and changes in the efficiency of a thermal power generator are reflected, and profits can be increased in total.

### BRIEF DESCRIPTION OF DRAWINGS

The foregoing and other objects, features, aspects and advantages of the present invention will become more apparent from the following detailed description of the present invention when taken in conjunction with the accompanying drawings.

FIG. 1 is a schematic diagram illustrating exchanges of electric power, fuel and steam carried out by an energy supply utility company according to Embodiment 1 of the present invention;

FIG. 2 is a schematic diagram illustrating flows of energy in energy markets according to the embodiments of the present invention;

FIG. 3 is an image diagram showing steam supply in an LNG-fired power generator according to the embodiments of the present invention;

FIG. 4 is a functional block diagram illustrating an energy demand-supply plan formulation apparatus according to Embodiment 1 of the present invention;

FIG. 5 is an image diagram showing a reserve power-generating capacity of an energy demand-supply plan formulation apparatus, and a margin of power-generation reduction thereof according to the embodiments of the present invention;

FIG. 6 is an example of a calculation result outputted from an energy demand-supply plan formulation apparatus according to the embodiments of the present invention, and is a diagram showing a relationship between the amount of electric power generation, and time;

FIG. 7 is another example of a calculation result outputted from an energy demand-supply plan formulation apparatus according to the embodiments of the present invention, and is a diagram showing a relationship between the amount of transaction in an electric power transaction market, and time;

FIG. 8 is a further example of a calculation result outputted from an energy demand-supply plan formulation apparatus according to the embodiments of the present invention, and is a diagram showing a relationship between the volume of a tank, and time;

FIG. 9 is a still further example of a calculation result outputted from an energy demand-supply plan formulation apparatus according to the embodiments of the present invention, and is a diagram showing a relationship between the amount of transaction in a fuel transaction market, and time;

FIG. 10 is a diagram showing a flowchart of a program which executes an energy demand-supply plan according to Embodiment 1 of the present invention;

FIG. 11 is a diagram showing from “Expression 1” to “Expression 4” related to Embodiment 1 of the present invention;

FIG. 12 is a diagram showing from “Expression 5” to “Expression 11” related to Embodiment 1 of the present invention;

FIG. 13 is a diagram showing from “Expression 12” to “Expression 17” related to Embodiment 1 of the present invention;

FIG. 14 is a diagram showing from “Expression 18” to “Expression 23” related to Embodiment 1 of the present invention;

FIG. 15 is a diagram showing from “Expression 24” to “Expression 27” related to Embodiment 1 of the present invention;

FIG. 16 is a diagram showing from “Expression 28” to “Expression 31” related to Embodiment 1 of the present invention;

FIG. 17 is a diagram showing from “Expression 32” to “Expression 34” related to Embodiment 1 of the present invention;

FIG. 18 is a diagram showing from “Expression 35” to “Expression 38” related to Embodiment 1 of the present invention;

FIG. 19 is a schematic diagram illustrating exchanges of electric power, fuel and steam carried out by an energy supply utility company according to Embodiment 2 of the present invention;

FIG. 20 is a diagram showing from “Expression 39” to “Expression 43” related to Embodiment 2 of the present invention;

FIG. 21 is a schematic diagram illustrating exchanges of electric power, fuel and steam carried out by an energy supply utility company according to Embodiment 3 of the present invention;

FIG. 22 is a diagram showing from “Expression 44” to “Expression 46” related to Embodiment 3 of the present invention;

FIG. 23 is a functional block diagram illustrating an energy demand-supply plan formulation apparatus according to Embodiment 4 of the present invention;

FIG. 24 is a diagram showing a flowchart of a program which executes an energy demand-supply plan according to Embodiment 4 of the present invention; and

FIG. 25 is a diagram showing “Expression 47” related to Embodiment 4 of the present invention.

### DETAILED DESCRIPTION OF THE PREFERRED EMBODIMENTS

Hereunder, an energy demand-supply plan formulation apparatus, an energy demand-supply plan formulation program, and an energy demand-supply plan formulation method according to embodiments of the present invention will be described with reference to the accompanying drawings. Note that, in each of the figures, the same or similar constituent items, portions or parts designate the same reference numerals and symbols, and a size and a scale corresponding to each of the constituent items, portions or parts are independent of one another. For example, there also arises a case in which a size and a scale of the same or similar constituent items, portions or parts may differ between sectional figures whose portions or parts of configurations are modified when the same or similar constituent items, portions or parts are shown in the figures without modifications thereto. In addition, configurations of the energy demand-supply plan formulation apparatus, the energy demand-supply plan formulation program and the energy demand-supply plan formulation method further include a plurality of members under actual circumstances; however, for brevity of explanation, those items, portions or parts required for explanation are only described, and so the explanation for other items, portions or parts is omitted.

### Embodiment 1

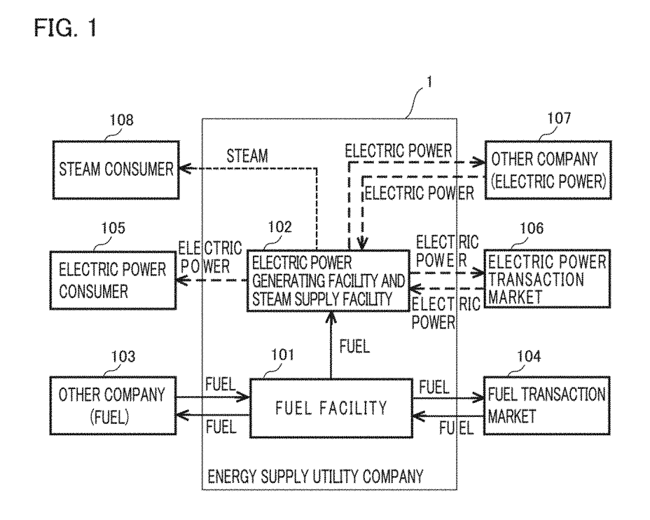

FIG. 1 is a schematic diagram illustrating the content of operations by an energy supply utility company according to Embodiment 1 of the present invention. An energy supply utility company 1 according to Embodiment 1 includes a fuel facility 101 and an electric power generating facility and steam supply facility 102, and performs exchanges of electric power, fuel and/or steam between the other company (fuel) 103, a fuel transaction market 104, an electric power consumer 105, an electric power transaction market 106, the other company (electric power) 107, a steam consumer 108. The fuel facility 101 is a storage facility of a tank or the like, and can store fuel.

The fuel handled by the fuel facility 101 according to the present invention is presumed to be liquefied natural gas (LNG), for example. On the other hand, it is presumed that fuel handled by the electric power generating facility and steam supply facility 102 is LNG, coal and oil, for example. The energy supply utility company 1 buys fuel from the other company (fuel) 103 by way of a fuel conveyance means of a fuel ship, a pipeline, a tank truck and so on, or sells fuel to the other company (fuel) 103. In addition, the energy supply utility company 1 can buy or sell fuel in the fuel transaction market 104. From the fuel facility 101, the fuel used for electric power generation and steam supply is supplied to the electric power generating facility and steam supply facility 102.

The electric power generating facility and steam supply facility 102 generates electric power by consuming the fuel supplied from the fuel facility 101, and sells the electric power to the electric power consumer 105 of a factory, a building or the like signing a contract to receive electricity. Moreover, in the electric power transaction market 106, the electric power generating facility and steam supply facility buys or sells electric power from/to the other company (electric power) 107. In the electric power generating facility and steam supply facility 102, steam is produced in the process of electric power generation. This steam is partly extracted and sold to the steam consumer 108 such as a factory and a building signing a steam supply contract. The electric power generating facility and steam supply facility 102 generates electric power by consuming not only the fuel (here, LNG) supplied from the fuel facility 101, but also the other fuel (coal, oil, or the like). In a buy and a sell of fuel from/to the other company (fuel) 103 performed by way of a fuel conveyance means of a fuel ship, a pipeline and so on, the buy and the sell are performed in accordance with a transaction price and the amount of transaction determined by a mutual agreement or contract exchanged between the energy supply utility company 1 and the other company (fuel) 103.

In the fuel transaction market 104, a plurality of utility companies and consumers make a bid for a transaction price and the amount of transaction of fuel for the buy and the sell in a predetermined period, and, by collecting those bids, a transaction price and the amount of transaction of fuel are determined in an individual period. The electric power consumer 105 of a factory, a building or the like signs a contract with the energy supply utility company 1 to receive electricity, and can purchase the electricity at a determined price so as not to exceed a contract level of electricity. In the electric power transaction market 106, a plurality of utility companies and consumers make a bid for a transaction price and the amount of transaction of electric power for the buy and the sell in a predetermined period, and, by collecting those bids, a transaction price and the amount of transaction of electric power are determined in an individual period.

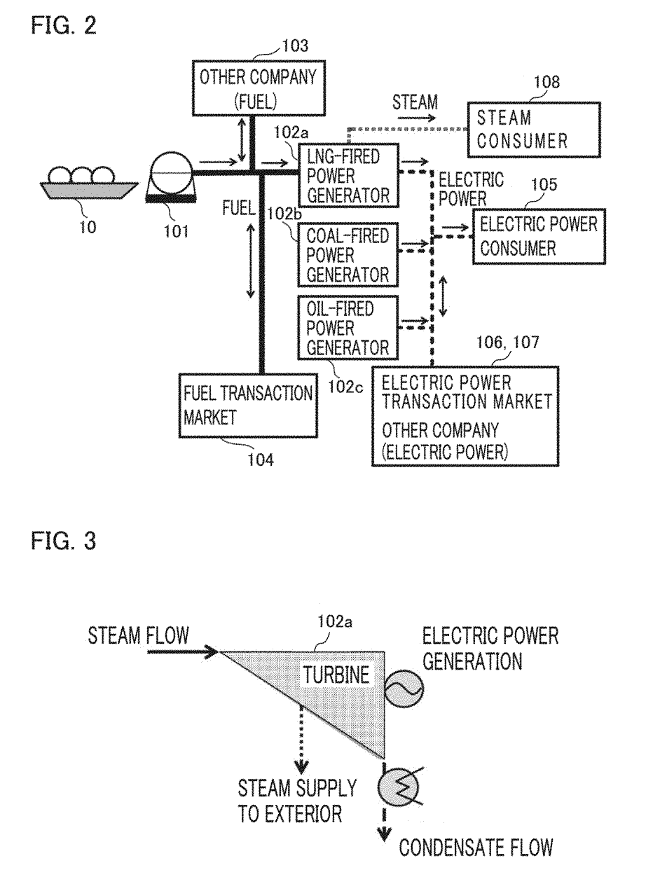

FIG. 2 is a schematic diagram illustrating flows of energy according to the embodiments of the present invention. Here, it is presumed that, for brevity of explanation, an LNG-fired power generator 102a (one plant) where LNG is used as its fuel, a coal-fired power generator 102b (one plant) where coal is used as its fuel, and an oil-fired power generator 102c (one plant) where oil is used as its fuel are possessed as an electric power generating facility. The LNG-fired power generator 102a, the coal-fired power generator 102b and the oil-fired power generator 102c are put in the category of thermal power generators. Among these generators, the LNG-fired power generator 102a using LNG as its fuel is handled also as a steam supply facility. In addition, it is presumed that the fuel facility 101 has one plant of tank, and that LNG from a fuel ship 10 is refueled into the tank, and the LNG is conveyed from the tank to the LNG-fired power generator 102a by way of a pipeline.

FIG. 3 is an image diagram showing flows of steam in the LNG-fired power generator according to the embodiments of the present invention. In the LNG-fired power generator 102a, steam is produced by burning LNG fuel. The steam is introduced into a turbine of the LNG-fired power generator 102a, so that electric power generation is performed. Steam extracted from a turbine is supplied to the exterior in order to sell the steam to the steam consumer 108 such as a factory and a building signing a steam supply contract. In the turbine, a portion of its steam becomes a condensate flow.

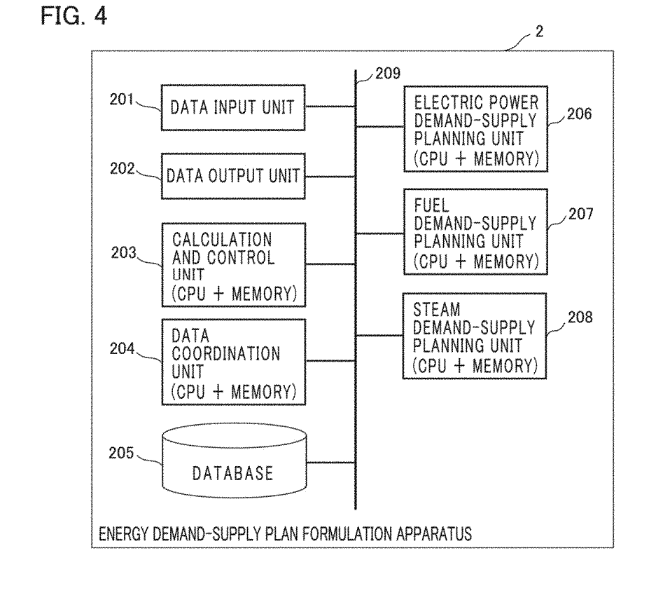

FIG. 4 is a functional block diagram illustrating an energy demand-supply plan formulation apparatus according to Embodiment 1 of the present invention. In Embodiment 1 of the present invention, the energy supply utility company 1 introduces an energy demand-supply plan formulation apparatus 2. On the energy demand-supply plan formulation apparatus 2, an energy demand-supply plan formulation program according to the embodiments of the present invention is mounted. The energy demand-supply plan formulation program is stored in a memory medium such as a disk and a memory, and supplied thereby for use. The energy demand-supply plan formulation program according to the embodiments of the present invention includes an energy demand-supply plan formulation method.

The energy demand-supply plan formulation apparatus 2 formulates a transaction plan in an electric power transaction market and in a fuel transaction market so that profits increases in an energy demand-supply plan, and further formulates an electric power demand-supply plan, a fuel demand-supply plan, and a steam demand-supply plan. The energy demand-supply plan formulation apparatus 2 is constituted of a data input unit 201, a data output unit 202, a calculation and control unit 203, a data coordination unit 204, a database 205, an electric power demand-supply planning unit 206, a fuel demand-supply planning unit 207 and a steam demand-supply planning unit 208, which are interconnected by a communications means 209. The electric power demand-supply plan includes the transaction plan in the electric power transaction market and an electric power generation plan therein.

The data input unit 201 fulfills the function for inputting information required for an energy demand-supply plan, and includes a monitor, a keyboard and a mouse, for example. A user of the apparatus operates the data input unit 201 so that data required in each of the functions into the database 205. By taking the configuration in that the data input unit 201 further includes a network interface device, data received by performing communications with external devices, for example, can be inputted into the database 205.

The data output unit 202 having the function for outputting a calculation result of an energy demand-supply plan includes a display device, a printing device and a magnetic disk device, for example. In addition, by taking the configuration in that the data output unit 202 further includes a network interface device, it is made possible to transmit the information on a calculation result of an energy demand-supply plan as an output to externally related devices.

The calculation and control unit 203 having the function for controlling the calculation of an energy demand-supply plan includes a monitor, a keyboard and a mouse, and also includes a central processing unit (CPU) and a dynamic random-access memory (DRAM), for example. The user of the apparatus operates the calculation and control unit 203 to input an instruction thereinto for a calculation-process start, so that the calculation and control unit 203 transmits instructions related to a calculation-process start of the electric power demand-supply planning unit 206, a calculation-process start of the fuel demand-supply planning unit 207 and a calculation-process start of the steam demand-supply planning unit 208, and also transmits an instruction related to data coordination to the data coordination unit 204.

In addition, the calculation and control unit 203 determines whether calculations in the electric power demand-supply planning unit 206, the fuel demand-supply planning unit 207 and the steam demand-supply planning unit 208 are converged; when they are converged, an instruction related to a calculation-process end is transmitted, and when they are not converged, an instruction related to a calculation-process continuation, transmitted. The calculation and control unit 203 manages the number of calculation repetitions, so that the number of calculation repetitions is initialized to “1” when an instruction of calculation-process start is received, and the number of calculation repetitions is incremented by “1” when the calculation-process continues. Moreover, by taking the configuration in that the calculation and control unit 203 further includes a network interface device, the calculation of an energy demand-supply plan can be made controllable, using received information, by performing communications with external devices, for example.

The data coordination unit 204 having the function for coordinating the data required for the calculation of an energy demand-supply plan includes a CPU and a DRAM, for example. The data coordination unit calculates an electric power-generation fuel-consumption plan, a reserve power-generating capacity, a margin of power-generation reduction, an electric power-generation unit-price and so on from a transaction plan in an electric power transaction market and an electric power generation plan therein which are a result calculated in the electric power demand-supply planning unit 206, and transmits these kinds of data to the fuel demand-supply planning unit 207; or the data coordination unit calculates specific heat consumption and the like, and transmits these kinds of data to the steam demand-supply planning unit 208. In the fuel demand-supply planning unit 207, a transaction plan in a fuel transaction market, an electric power-generation correction plan and an operational plan of fuel tank are formulated. In the steam demand-supply planning unit 208, a steam demand-supply plan is formulated.

From a steam demand-supply plan which is a result calculated by the steam demand-supply planning unit 208, a change in heat consumption or the like of a power generator according to its steam supply is calculated, and these kinds of data are transmitted to the electric power demand-supply planning unit 206. In addition, a tank fuel unit-price, the amount of tank-fuel heat, an lower or upper limit value of a fuel-consumption amount constraint and so on are calculated from a transaction plan in the fuel transaction market, an electric power-generation correction plan, and an operational plan of fuel tank which are results calculated by the fuel demand-supply planning unit 207; and these kinds of data are transmitted to the electric power demand-supply planning unit 206.

The database 205 is a memory device for storing data required for the calculation of an energy demand-supply plan, and is implemented by a magnetic disk device, for example. In the database 205, stored are electric power demand, a fuel unit-price, the amount of fuel heat, a power-generation characteristic of an electric power generating facility, an electric power-generation amount lower or upper limit value of an electric power generating facility, an electric power-generation change-amount lower or upper limit value of an electric power generating facility, a heat-consumption change characteristic according to steam supply of an electric power generating facility, an electric power market price, a transaction-amount lower or upper limit value in an electric power transaction market, a transaction plan according to a mutual fuel contract, a shipping plan, a pipeline-conveyance lower or upper limit value, a fuel market price, a transaction-amount lower or upper limit value in a fuel transaction market, a fuel-market heat amount, an initial tank-fuel unit-price, an initial amount of tank-fuel heat, an initial tank volume, a final tank volume, a tank-volume lower or upper limit value, and so on.

The electric power demand-supply planning unit 206 having the function for performing the calculation of an electric power demand-supply plan in an energy demand-supply plan includes a CPU and a DRAM, for example. The electric power demand-supply planning unit 206 receives an instruction from the calculation and control unit 203, and outputs a transaction plan in an electric power transaction market and an electric power generation plan therein by taking, as input data, electric power demand, a fuel unit-price, the amount of fuel heat, a power-generation characteristic of an electric power generating facility, an electric power-generation amount lower or upper limit value of an electric power generating facility, an electric power-generation change-amount lower or upper limit value of an electric power generating facility, an electric power market price, a transaction-amount lower or upper limit value in an electric power transaction market, a tank fuel unit-price, the amount of tank-fuel heat, an lower or upper limit value of a fuel-consumption amount constraint and so on, so that the electric power demand is satisfied, and the profits are maximized.

The fuel demand-supply planning unit 207 having the function for performing the calculation of a fuel demand-supply plan in an energy demand-supply plan includes a CPU and a DRAM, for example. The fuel demand-supply planning unit 207 receives an instruction from the calculation and control unit 203, and outputs a transaction plan in a fuel transaction market, an electric power-generation correction plan, and an operational plan of fuel tank by taking, as input data, a transaction plan according to a mutual fuel contract, a shipping plan, a pipeline-conveyance lower or upper limit value, a fuel market price, a transaction-amount lower or upper limit value in a fuel transaction market, a fuel-market heat amount, an initial tank-fuel unit-price, an initial amount of tank-fuel heat, an initial tank volume, a final tank volume, a tank-volume lower or upper limit value, an electric power-generation fuel-consumption plan, a reserve power-generating capacity, a margin of power-generation reduction, an electric power-generation unit-price, an electric power market unit-price and so on, so that the amount of transaction according to a mutual fuel contract is satisfied, and the profits are maximized.

The steam demand-supply planning unit 208 having the function for performing the calculation of a steam demand-supply plan in an energy demand-supply plan includes a CPU and a DRAM, for example. The steam demand-supply planning unit 208 receives an instruction from the calculation and control unit 203, and outputs a steam demand-supply plan with respect to a steam supply contract and a heat-consumption change characteristic of an electric power generating facility by taking, as input data, steam demand, a supply price on a steam supply contract, a heat-consumption change characteristic according to steam supply of an electric power generating facility, a fuel unit-price, the amount of fuel heat, a power-generation characteristic of an electric power generating facility, an electric power-generation amount lower or upper limit value of an electric power generating facility, an electric power-generation change-amount lower or upper limit value of an electric power generating facility, an electric power market price, a transaction-amount lower or upper limit value in an electric power transaction market and so on, so that fuel costs caused by an increase in fuel consumption according to the steam supply are minimized.

The communications means 209 is a means performing communications between the data input unit 201, the data output unit 202, the calculation and control unit 203, the data coordination unit 204, the database 205, the electric power demand-supply planning unit 206, the fuel demand-supply planning unit 207 and the steam demand-supply planning unit 208, and is achieved by a network facility of an optical line or the like, for example.

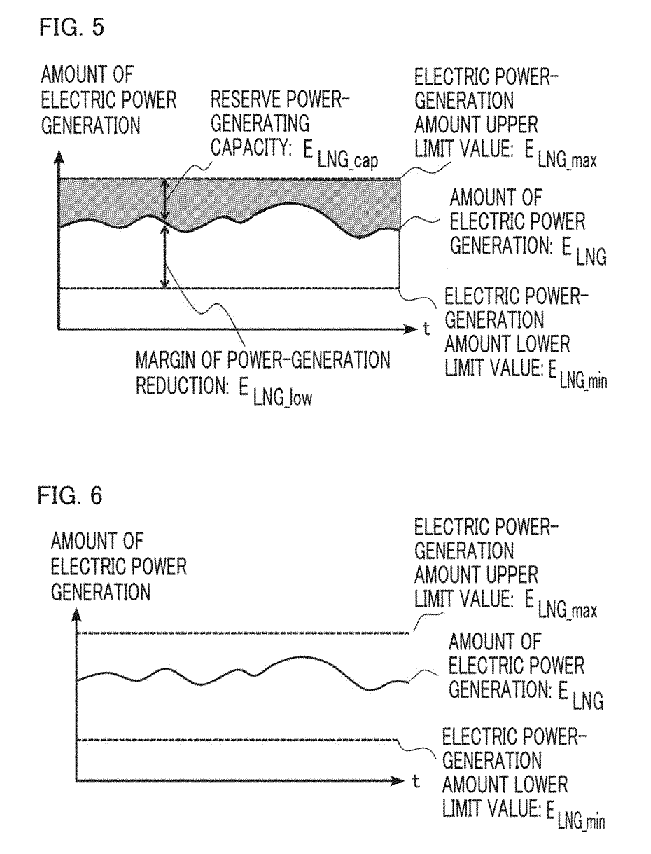

FIG. 5 is an image diagram showing a reserve power-generating capacity of the energy demand-supply plan formulation apparatus, and a margin of power-generation reduction thereof according to Embodiment 1 of the present invention. The amount of electric power generation (ELNG) is always varying. The difference between an electric power-generation amount upper limit value (ELNG-max) and the amount of electric power generation (ELNG) corresponds to a reserve power-generating capacity (ELNG-cap). The difference between the amount of electric power generation (ELNG) and an electric power-generation amount lower limit value (ELNG-min) corresponds to a margin of power-generation reduction (ELNG-low).

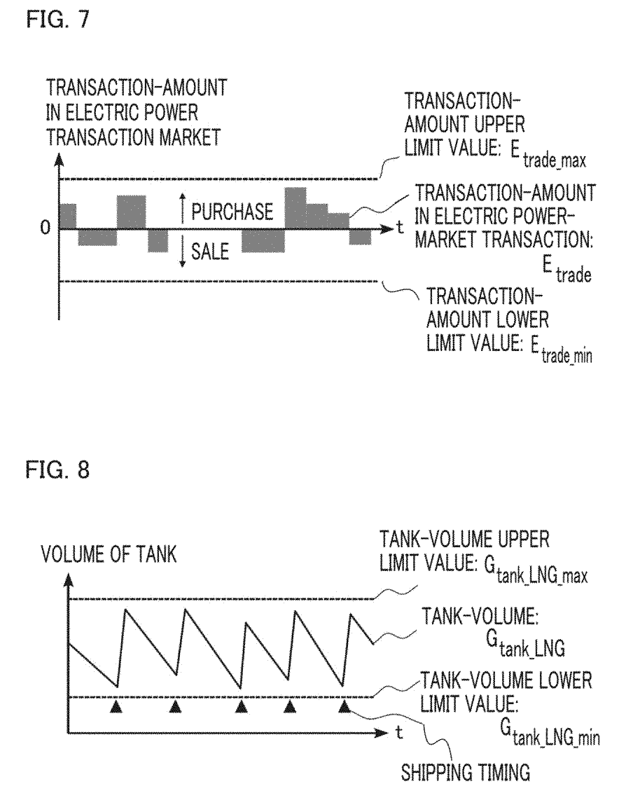

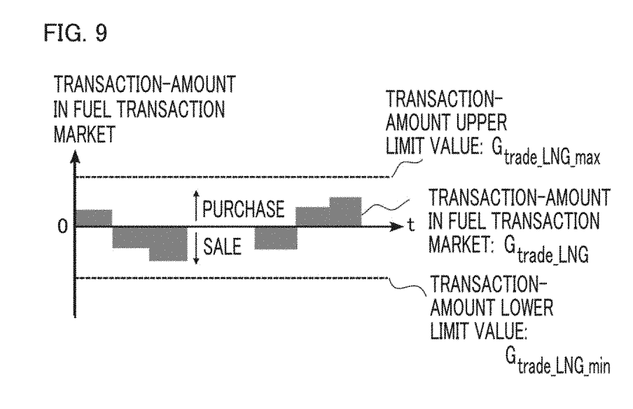

FIG. 6 is an output example of a calculation result from the energy demand-supply plan formulation apparatus according to the embodiments of the present invention, and is a diagram showing a relationship between the amount of electric power generation, and time. FIG. 7 is another output example of a calculation result similarly from the energy demand-supply plan formulation apparatus according to the embodiments of the present invention, and is a diagram showing a relationship between the amount of transaction in an electric power transaction market, and time. FIG. 8 is a further output example of a calculation result similarly from the energy demand-supply plan formulation apparatus according to the embodiments of the present invention, and is a diagram showing a relationship between the volume of a tank, and time. FIG. 9 is a still further output example of a calculation result similarly from the energy demand-supply plan formulation apparatus according to the embodiments of the present invention, and is a diagram showing a relationship between the amount of transaction in a fuel transaction market, and time.

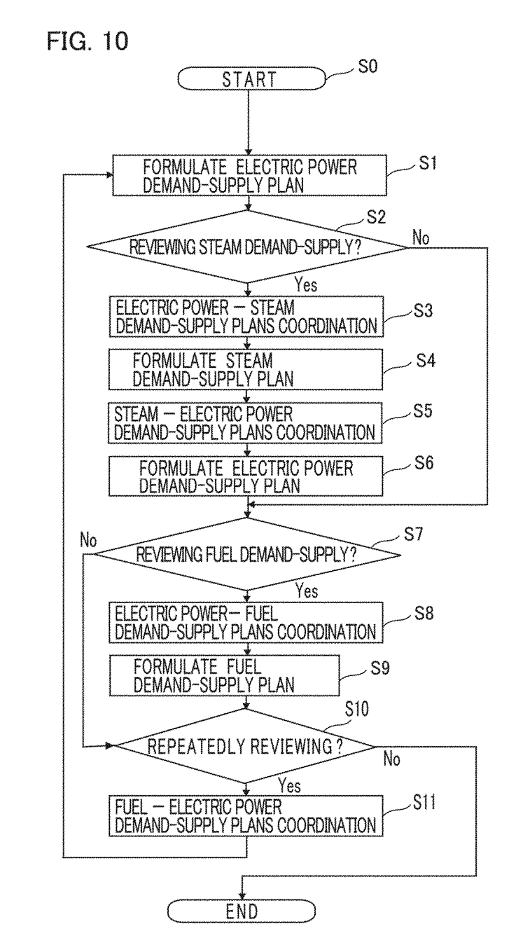

FIG. 10 is a flowchart showing the execution procedures of the energy demand-supply plan formulation program according to Embodiment 1 of the present invention. The energy demand-supply plan formulation program is stored in a memory medium and supplied thereby, and executed by a computer (energy demand-supply plan formulation apparatus 2) which formulates an energy demand-supply plan. Hereinafter, it is presumed that an energy demand-supply plan for the amount of one year is formulated in every intervals of thirty minutes, and that one period is set for thirty minutes. However, the apparatus is not limited to these; it is possible to formulate an energy demand-supply plan in an arbitrarily interval and an arbitrarily period.

Before the calculation processing starts, a user of the energy demand-supply plan formulation apparatus 2 performs data setting. To be specific, in the data input unit 201, inputted are electric power demand, a fuel unit-price, the amount of fuel heat, a power-generation characteristic of an electric power generating facility, an electric power-generation amount lower or upper limit value of an electric power generating facility, an electric power-generation change-amount lower or upper limit value of an electric power generating facility, an electric power market price, a transaction-amount lower or upper limit value in an electric power transaction market, a transaction plan according to a mutual fuel contract, a shipping plan, a pipeline-conveyance lower or upper limit value, a fuel market price, a transaction-amount lower or upper limit value in a fuel transaction market, a fuel-market heat amount, an initial tank-fuel unit-price, an initial amount of tank-fuel heat, an initial tank volume, a final tank volume, a tank-volume lower or upper limit value, steam demand, a supply price on a steam supply contract, a heat-consumption change characteristic according to steam supply of an electric power generating facility and so on. However, input data related to a time series is inputted in conformance with the time series. Here, the data for the amount of one year is inputted in every intervals of thirty minutes.

Here, specific examples of data to input are shown as follows. The electric power demand (Edem) indicates electric power demand in which the energy supply utility company 1 should fulfill the supply to a consumer in an individual period. A power-generation characteristic of an electric power generating facility is set for every one of electric power generating facilities, and is a characteristic indicating the relationship between the amount of consumption heat in each of electric power generating facilities (=the amount of fuel consumption×the amount of fuel heat) and the amount of electric power generation (E), so that the characteristic can be expressed by a mathematical expression, a graph and/or the like.

A power-generation characteristic (fLNG) indicates that of an LNG-fired power generator. A power-generation characteristic (fCoal) indicates that of a coal-fired power generator. A power-generation characteristic (fOil) indicates that of a oil-fired power generator. In addition, the amount of fuel consumption (Ggen-LNG) indicates that of the LNG-fired power generator. The amount of fuel consumption (GCoal) indicates that of the coal-fired power generator. The amount of fuel consumption (GOil) indicates that of the oil-fired power generator.

A fuel unit-price is a value used for calculating an electric power generation profit, and is set in every kinds of fuel. Here, a tank fuel unit-price (Ptank-LNG) indicates a fuel unit-price of LNG supplied to the LNG-fired power generator. A fuel unit-price (PCoal) indicates that of coal supplied to the coal-fired power generator. A fuel unit-price (POil) indicates that of the oil-fired power generator.

The amount of fuel heat is a value used for calculating the amount of electric power generation of an electric power generating facility, and is set in every kinds of fuel. Here, the amount of tank-fuel heat (Htank-LNG) indicates the amount of fuel heat of LNG supplied to the LNG-fired power generator. The amount of fuel heat (HCoal) indicates that of coal supplied to the coal-fired power generator. The amount of fuel heat (HOil) indicates that of oil supplied to the oil-fired power generator.

An electric power-generation amount lower or upper limit value indicates a range in which each of electric power generating facilities can generate electric power. An LNG-fired power-generator lower or upper limit value (ELNG-min, ELNG-max), a coal-fired power-generator lower or upper limit value (ECoal-min, ECoal-max) and an oil-fired power-generator lower or upper limit value (EOil-min, EOil-max) indicate an electric power-generation amount lower or upper limit value corresponding to an electric power generating facility, respectively. An electric power-generation change-amount lower or upper limit value indicates a range in which the amount of electric power generation in each of electric power generating facilities can change from a certain period to a next period. An LNG-fired power-generator lower or upper limit value (VLNG-min, VLNG-max), a coal-fired power-generator lower or upper limit value (VCoal-min, VCoal-max) and an oil-fired power-generator lower or upper limit value (VOil-min, VOil-max) indicate an electric power generation change-amount lower or upper limit value corresponding to an electric power generating facility, respectively.

An electric power market price (Ptrade-ele) is a price in an individual period in an electric power market in which the energy supply utility company 1 makes a bid. A transaction-amount lower or upper limit value (Etrade-min, Etrade-max) in an electric power transaction market is a lower limit value or an upper limit value for indicating a range of the amount of transaction in an electric power-market transaction. A transaction plan according to a mutual fuel contract includes the amount of fuel transaction (Gcont-LNG), the amount of heat (Hcont-LNG), a price (Pcont-LNG) in which the energy supply utility company 1 determines in advance with the other company by an agreement or contract. Here it is so arranged that a transaction according to a mutual fuel contract is exchanged by way of a pipeline.

A shipping plan includes, in fuel in which the energy supply utility company 1 supplies to a fuel facility, the amount of supply (Gship-LNG) of the fuel, the amount of heat (Hship-LNG) thereof and a price (Pship-LNG) thereof conveyed by a fuel ship in an individual period. A pipeline-conveyance lower or upper limit value (Gpipe-LNG-min, Gpipe-LNG-max) is a lower limit value or an upper limit value for indicating a range in which the fuel facility can perform the conveyance by way of a pipeline. A fuel market price (Ptrade-LNG) is a price in an individual period in a fuel market in which the energy supply utility company 1 makes a bid.

A fuel-market heat amount (Htrade-LNG) is the amount of heat in an individual period in a fuel market in which the energy supply utility company 1 makes a bid. A transaction-amount lower or upper limit value (Gtrade-LNG-min, Gtrade-LNG-max) in a fuel transaction market is a lower limit value or an upper limit value for indicating a range of the amount of transaction in a fuel-market transaction. An initial tank-fuel unit-price (Ptank-LNG-start) is an early stage unit-price in a planning period of the fuel stored in a tank of the fuel facility. An initial amount of tank-fuel heat (Htank-LNG-start) is an early stage amount of heat in a planning period of the fuel stored in a tank of the fuel facility.

An initial tank volume (Gtank-LNG-start) is an early stage volume in a planning period of the fuel stored in a tank of the fuel facility. A final tank volume (Gtank-LNG-end) is the volume of fuel that should be stored in a tank of the fuel facility at a final stage in a planning period. A tank-volume lower or upper limit value (Gtank-LNG-min, Gtank-LNG-max) is a lower limit value or an upper limit value for indicating a range of the amount of fuel in which a tank of the fuel facility can store inside. Steam demand (STdem) on a steam supply contract indicates the demand of steam which should be supplied when the energy supply utility company 1 performs steam supply to a steam consumer.

A characteristic of a change in heat consumption according to steam supply of an electric power generating facility is set for every one of power generators, and is a characteristic indicating a change of electric power generation characteristic according to each of the power generators supplying the steam, so that the characteristic can be expressed by a mathematical expression, a graph and the like. Here, a change characteristic (fCSLNG) is a heat-consumption change characteristic of an LNG-fired power generator. In the data setting before the calculation processing starts, the amount of tank-fuel heat in an individual period and a tank fuel unit-price therein are inputted as constant values (an initial tank-fuel unit-price for the latter, and a corresponding value to the initial tank-fuel unit-price for the former). In addition, a determination value 1 (D1) used in the calculation and control unit 203 for convergence determination, and also a determination value 2 (D2) used therefor are inputted. The inputted data is stored in the database 205.

After performing the data setting, the user of the apparatus operates to input an instruction of a calculation-process start for the calculation and control unit 203 thereinto, so that the calculation processing is started (Step S0). In the energy demand-supply plan formulation apparatus 2, the instruction of a calculation-process start inputted into the calculation and control unit 203 is received, so that an instruction of a calculation-process start is transmitted to the electric power demand-supply planning unit 206.

At Step S1 as shown in the figure, an electric power demand-supply plan is formulated. To be specific, in the electric power demand-supply planning unit 206, a transaction plan in an electric power transaction market and an electric power generation plan therein are outputted by taking, as input data, electric power demand, a fuel unit-price, the amount of fuel heat, a power-generation characteristic of an electric power generating facility, an electric power-generation amount lower or upper limit value of an electric power generating facility, an electric power-generation change-amount lower or upper limit value of an electric power generating facility, an electric power market price, a tank fuel unit-price, the amount of tank-fuel heat, an lower or upper limit value of a fuel-consumption amount constraint and so on, so that the electric power demand is satisfied, and the profits are maximized.

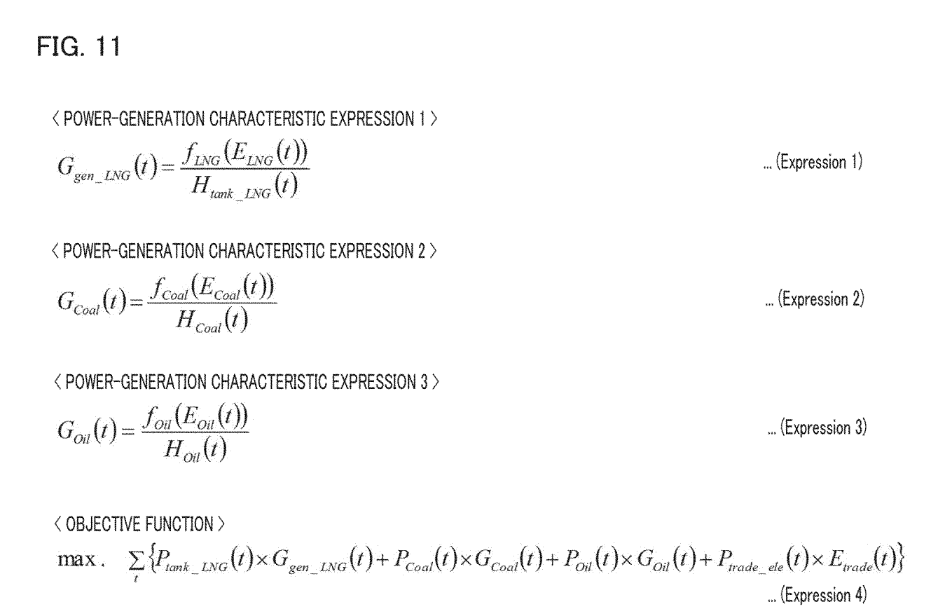

Here, an index designating an individual period is “t.” In the electric power demand-supply planning unit 206, an optimization problem including a power-generation characteristic expression, an objective function and a constraint condition is formed in advance as follows. A power-generation characteristic expression is set for each of electric power generating facilities, and can be expressed such as Expression 1 through Expression 3, for example (refer to FIG. 11). An objective function is set as a profit obtained by summing up expense of fuel consumed according to an electric power generation, and income or expense according to transactions in an electric power transaction market; and thus an object of optimization calculation is to maximize the profit. An objective function can be expressed such as Expression 4, for example (refer to FIG. 11).

In addition, as constraint conditions, an electric power-generation amount constraint, an electric power-generation change-amount constraint, a transaction amount constraint in an electric power transaction market, a fuel-consumption amount constraint, and an electric power demand-supply balance expression are set. The electric power-generation amount constraint indicates a range in which the amount of electric power generation (E) of each of power generators of an electric power generating facility can take in an individual period. The electric power-generation change-amount constraint indicates a range in which the amount of electric power generation of an electric power generating facility can be changed from a certain period to a next period. The transaction amount constraint in an electric power transaction market indicates a range in which the amount of transaction (Etrade) in the electric power transaction market can take in an individual period. The fuel-consumption amount constraint indicates a range in which a sum-total of the amount of fuel consumption from a certain predetermined period (tstart (s)) to the following predetermined period (tend (s)) can take. The electric power demand-supply balance expression is an equation for ensuring the balance between demand of electric power and supply thereof.

The amount of electric power generation (ELNG) indicates that of an LNG-fired power generator. The amount of electric power generation (ECoal) indicates that of a coal-fired power generator. The amount of electric power generation (EOil) indicates that of a oil-fired power generator. However, a lower limit value (Gcons-LNG-min) is set at that of the fuel-consumption amount constraint in an LNG-fired power generator, and an upper limit value (Gcons-LNG-max), at that of the fuel-consumption amount constraint in the LNG-fired power generator. An index for distinguishing each of the fuel-consumption amount constraints is “s.”

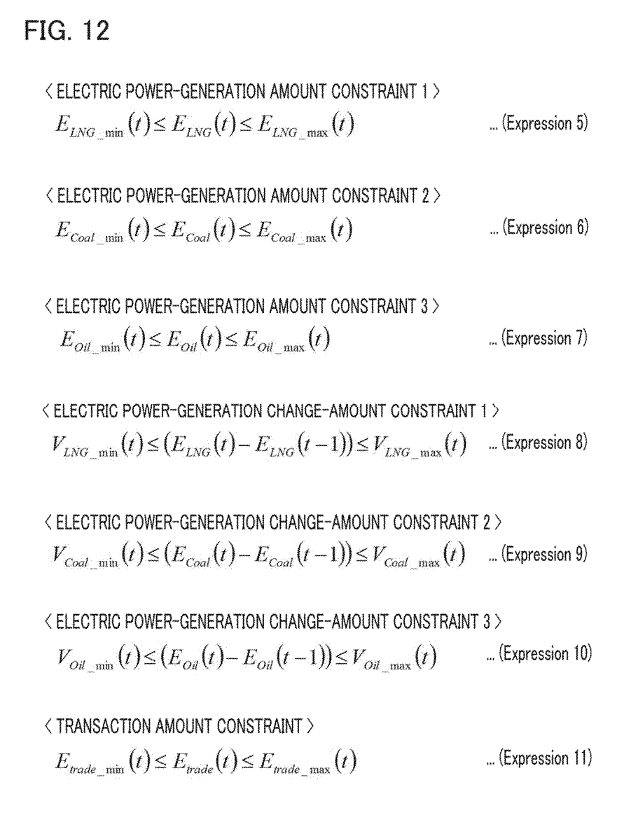

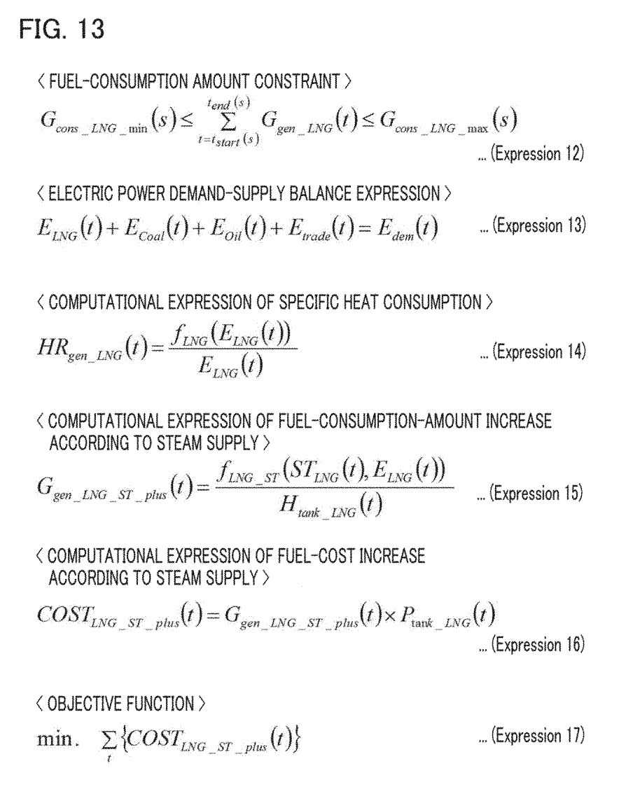

Electric power-generation amount constraints can be expressed such as Expression 5 through Expression 7, for example (refer to FIG. 12). Electric power-generation change-amount constraints can be expressed such as Expression 8 through Expression 10, for example (refer to FIG. 12). A transaction amount constraint in an electric power transaction market can be expressed such as Expression 11, for example (refer to FIG. 12). A fuel-consumption amount constraint can be expressed such as Expression 12, for example (refer to FIG. 13). The electric power demand-supply balance expression can be expressed such as Expression 13, for example (refer to FIG. 13).

As optimization schemes to solve an optimization problem, an optimization scheme of linear programming or the like is applied when an optimization problem is a linear programming problem; that of mixed integer linear-programming or the like, when an optimization problem is a mixed integer linear-programming problem including integers; that of two-dimensional programming or the like, when an optimization problem is a two-dimensional programming problem; and that of meta-heuristics or the like, when an optimization problem is a non-linear programming problem. From inputted data being set by the data input unit 201, parameters for inputting for an optimization problem are calculated, and those parameters are inputted for the optimization problem; by using an optimization scheme, an optimized solution to maximize a profit, namely, a transaction plan in an electric power transaction market and an electric power generation plan therein are obtained.

At Step S2, based on an electric power demand-supply plan being formulated, determination is performed whether a steam demand-supply plan is to be formulated. It is required to formulate the steam demand-supply plan at least once. For example, a case is conceivable in which, in order to review a steam demand-supply plan, formulation is always performed by reflecting the results of an electric power demand-supply plan and a fuel demand-supply plan. For dealing therewith, another case is also conceivable in which, in order to lower the frequency of planning formulation processing, formulation is performed at initial passage in the flows, or a steam demand-supply plan is formulated after an electric power demand-supply plan and a fuel demand-supply plan are formulated for a plurality of times.

At Step S3, coordination data for a steam demand-supply plan (first coordination data) is formed. To be specific, in the data coordination unit 204, an electric power-generation unit-price, specific heat consumption and so on are calculated from an electric power generation plan being a result calculated by the electric power demand-supply planning unit 206, these kinds of data are transmitted to the steam demand-supply planning unit 208. The specific heat consumption calculated from the amount of heat consumption of each of power generators and an output thereof. A computational expression of specific heat consumption (HRgen-LNG) can be expressed such as Expression 14, for example (refer to FIG. 13).

At Step S4, a steam demand-supply plan is formulated. To be specific, in the steam demand-supply planning unit 208, inputted as its input data are information of a supply price on a steam supply contract and the amount of supply thereon, a steam supply characteristic (fLNG-ST) indicating the amount of consumption heat according to steam supply by a power generator, a steam-supply lower or upper limit value of each of power generators, a fuel unit-price and so on, and a steam demand-supply plan which maximizes profits is outputted. In the steam demand-supply planning unit 208, an optimization problem including a computational expression, an objective function and a constraint condition is formed in advance as follows.

As computational expressions, the computational expressions are set for a fuel-consumption-amount increase according to steam supply, and for a fuel-cost increase thereby. A computational expression of a fuel-consumption-amount increase (Ggen-LNG-ST-plus) with respect to the amount of steam supply (STLNG) can be expressed by Expression 15, for example (refer to FIG. 13). A computational expression of a fuel-cost increase (COSTLNG-ST-plus) with respect to the amount of steam supply (STLNG) can be expressed by Expression 16, for example (refer to FIG. 13). As the objective function, an object of optimization calculation is to minimize a fuel-cost increase according to steam supply. An objective function can be expressed such as Expression 17, for example (refer to FIG. 13).

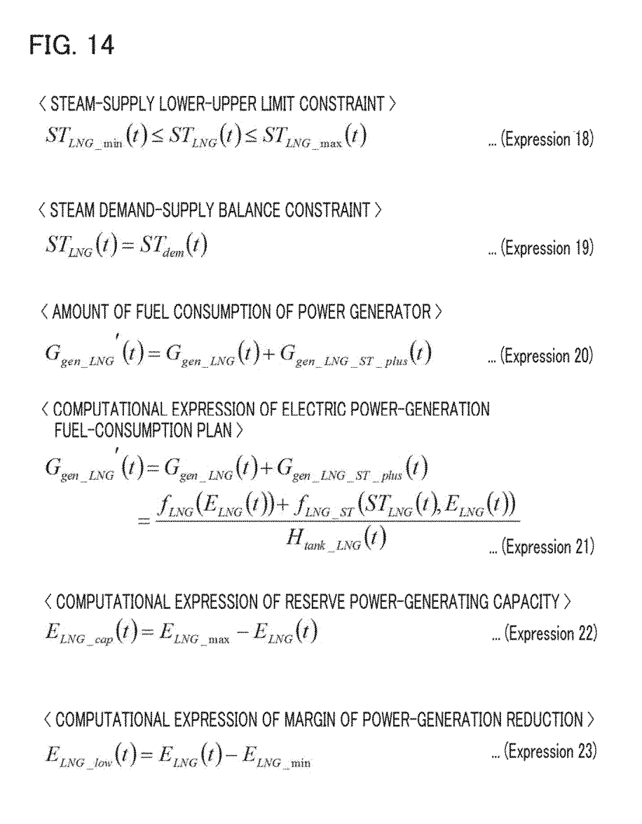

In addition, as constraint conditions, being set are a range in which an individual power generator can supply its steam (steam-supply lower-upper limit constraint), and a steam demand-supply balance constraint for securing the amount of steam supply required on a steam supply contract. A steam-supply lower-upper limit constraint can be expressed such as Expression 18, for example (refer to FIG. 14). A steam-supply lower or upper limit value (STLNG-min, STLNG-max) is a lower or upper limit value indicating a range of the amount of steam in which a power generator can supply. A steam demand-supply balance constraint with respect to steam demand (STdem) of the steam consumer 108 can be expressed such as Expression 19, for example (refer to FIG. 14).

At Step S5, coordination data for an electric power demand-supply plan (second coordination data) is formed. To be specific, in the data coordination unit 204, the amount of fuel consumption or the like of a power generator in which the amount changes according to steam supply is calculated from a steam demand-supply plan result being a result calculated by the steam demand-supply planning unit 208, and these kinds of data are transmitted to the electric power demand-supply planning unit 206. The amount of fuel consumption (Ggen-LNG′) of a power generator in consideration of the amount of fuel consumption which increases according to steam supply can be expressed by Expression 20, for example (refer to FIG. 14).

At Step S6, an electric power demand-supply plan is formulated. To be specific, in the electric power demand-supply planning unit 206 in which similar processing is performed as for Step S1, a transaction plan and an electric power generation plan are outputted, in consideration of steam supply, by using a power-generation characteristic formed at Step S5.

At Step S7, based on an electric power demand-supply plan being formulated, determination is performed on the presence or absence of performing a fuel demand-supply planning process. It is required to formulate the fuel demand-supply plan at least once. For example, a case is conceivable in which, in order to review a fuel demand-supply plan, formulation is always performed by reflecting the results of an electric power demand-supply plan and a steam demand-supply plan. For dealing therewith, another case is also conceivable in which, in order to lower the frequency of planning formulation processing, formulation is performed at initial passage in the flows, or a fuel demand-supply plan is formulated after an electric power demand-supply plan and a steam demand-supply plan are formulated for a plurality of times.

At Step S8, coordination data for a fuel demand-supply plan (third coordination data) is formed. To be specific, in the data coordination unit 204, an electric power-generation fuel-consumption plan, a reserve power-generating capacity, a margin of power-generation reduction, an electric power-generation unit-price and so on are calculated from a transaction plan in the electric power transaction market and an electric power generation plan therein which are results calculated by the electric power demand-supply planning unit 206, and these kinds of data are transmitted to the fuel demand-supply planning unit 207. The data coordination unit 204 extracts the amount of electric power generation of an LNG-fired power generator from an electric power generation plan for an individual period, and, from a power-generation characteristic of the LNG-fired power generator stored in the database 205, the amount of fuel consumption in the LNG-fired power generator is reversely calculated for an individual period, so that an electric power-generation fuel-consumption plan is formed.

The computational expression for the amount of electric power-generation fuel-consumption can be expressed such as Expression 21, for example (refer to FIG. 14). The amount of electric power generation of an LNG-fired power generator is extracted from an electric power generation plan for an individual period, and, from an electric power-generation amount lower or upper limit value of the LNG-fired power generator stored in the database 205, a reserve power-generating capacity (ELNG-cap) in the LNG-fired power generator and a margin of power-generation reduction (ELNG-low) therein are calculated for an individual period (refer to FIG. 6). A computational expression for a reserve power-generating capacity (ELNG-cap) can be expressed such as Expression 22, for example (refer to FIG. 14). A computational expression for a margin of power-generation reduction (ELNG-low) can be expressed such as Expression 23, for example (refer to FIG. 14).

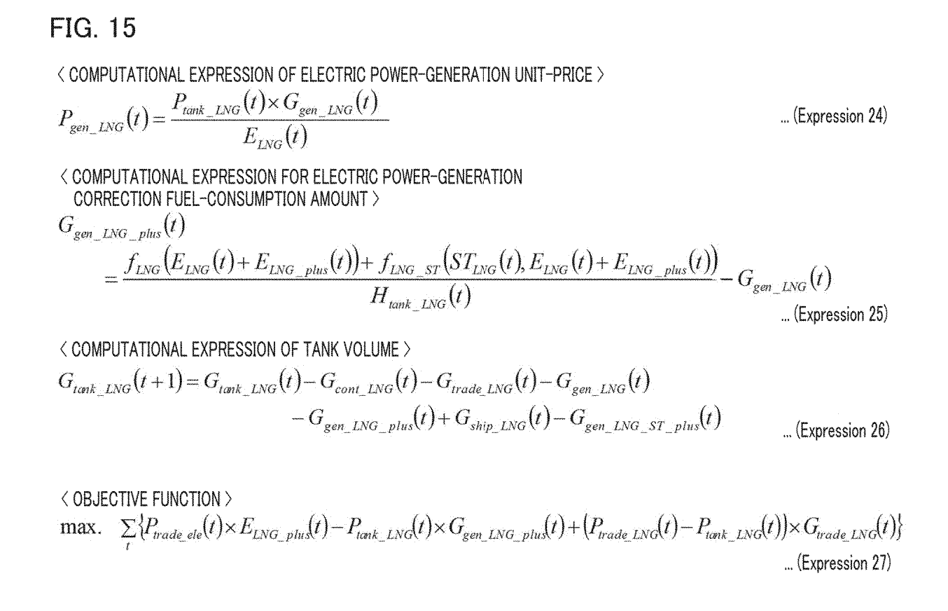

In addition, the amount of electric power generation of an LNG-fired power generator is extracted from an electric power generation plan for an individual period, and, in relation to the LNG-fired power generator indicating the amount of electric power generation being intermediate without reaching an electric power-generation amount lower or upper limit value, an electric power-generation unit-price (Pgen-LNG) in the LNG-fired power generator calculated for an individual period from a power-generation characteristic of the LNG-fired power generator, the amount of tank-fuel heat and a tank fuel unit-price stored in the database 205. Here, because one plant is presumed for the LNG-fired power generator, the electric power-generation unit-price is calculated in relation to the LNG-fired power generator. A computational expression for an electric power-generation unit-price can be expressed such as Expression 24, for example (refer to FIG. 15). These reserve power-generating capacity, a margin of power-generation reduction and an electric power-generation unit-price are used as a reserve power-generating capacity, a margin of power-generation reduction and an electric power-generation unit-price when an electric power-generation correction plan is formulated in the fuel demand-supply planning unit 207.

At Step S9, a fuel demand-supply plan is formulated. To be specific, in the fuel demand-supply planning unit 207, inputted as input data are a transaction plan according to a mutual fuel contract, a shipping plan, a pipeline-conveyance lower or upper limit value, a fuel market price, a transaction-amount lower or upper limit value in a fuel transaction market, a fuel-market heat amount, an initial tank-fuel unit-price, an initial amount of tank-fuel heat, an initial tank volume, a final tank volume, a tank-volume lower or upper limit value, an electric power generation plan, an electric power-generation fuel-consumption plan, a reserve power-generating capacity, a margin of power-generation reduction, an electric power-generation unit-price, an electric power market unit-price and so on, a transaction plan in a fuel transaction market, an electric power-generation correction plan, and an operational plan of fuel tank are outputted so that the amount of transaction according to a mutual fuel contract is satisfied, and profits are maximized.

In the fuel demand-supply planning unit 207, an optimization problem including a computational expression, an objective function and a constraint condition is formed in advance as follows. As a computational expression, the computational expression is set for calculating an electric power-generation correction fuel-consumption amount (Ggen-LNG-plus) required for electric power-generation correction. A computational expression for the electric power-generation correction fuel-consumption amount can be expressed such as Expression 25, for example (refer to FIG. 15). Moreover, in relation to the volume of a tank (Gtank-LNG), a computational expression is set for calculating the volume of a tank in a next period from the volume of a tank and the amount of fuel consumption in a certain period. A computational expression for the volume of a tank (Gtank-LNG) in a next period can be expressed such as Expression 26, for example (refer to FIG. 15).

The objective function is set as a profit by summing up the balance of accounts on a buy and a sell of electric power in an electric power market according to an electric power-generation correction, the balance of accounts of fuel consumption according to an electric power-generation correction, and income or expense according to transactions in a fuel transaction market; and thus an object of optimization calculation is to maximize the profit. The objective function can be expressed such as Expression 27, for example (refer to FIG. 15).

In addition, as constraint conditions, being set are a range in which the amount of electric power-generation change (ELNG-plus) can take in an individual period (an electric power-generation correction-amount constraint), a range in which the amount of electric power generation of electric power generating facility can change the amount from a certain period to a next period in consideration of the amount of electric power-generation correction (an electric power-generation change-amount constraint taking the amount of electric power-generation correction into consideration), a range in which the amount of transaction (Gtrade-LNG) in a fuel transaction market can take in an individual period (transaction amount constraint in a fuel-market transaction), a range in which the amount of pipeline-conveyance can take (fuel-conveyance amount constraint), and a range in which the volume of a tank can take (tank volume constraint).

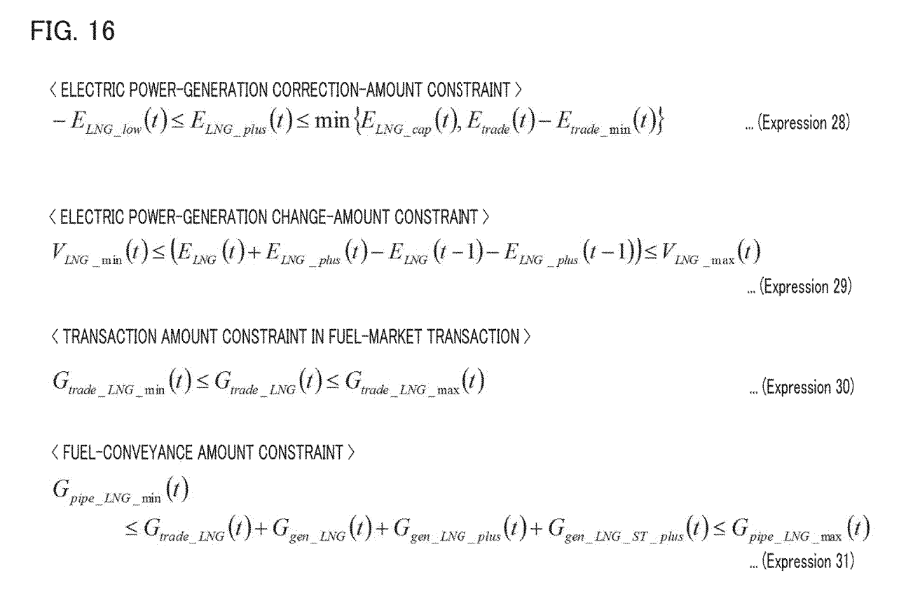

The electric power-generation correction-amount constraint can be expressed such as Expression 28, for example (refer to FIG. 16). The electric power-generation change-amount constraint taking the amount of electric power-generation correction into consideration can be expressed such as Expression 29, for example (refer to FIG. 16). The transaction amount constraint in a fuel-market transaction can be expressed such as Expression 30, for example (refer to FIG. 16). The fuel-conveyance amount constraint can be expressed such as Expression 31, for example (refer to FIG. 16).

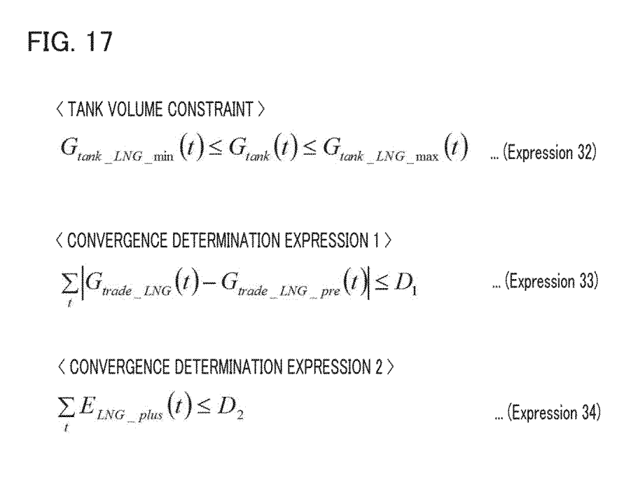

A tank volume constraint can be expressed such as Expression 32, for example (refer to FIG. 17). As optimization schemes to solve an optimization problem, an optimization scheme of linear programming or the like is applied when an optimization problem is a linear programming problem; that of mixed integer linear-programming or the like, when an optimization problem is a mixed integer linear-programming problem including integers; that of two-dimensional programming or the like, when an optimization problem is a two-dimensional programming problem; and that of meta-heuristics or the like, when an optimization problem is a non-linear programming problem.

At Step S10, determination is performed whether individual planning formulation is required to be repeatedly performed. For example, determination is performed for convergence of an energy demand-supply plan, and determination is performed for repetition. To be specific, in the calculation and control unit 203, determination is performed whether calculations in the electric power demand-supply planning unit 206 and the fuel demand-supply planning unit 207 are converged; when they are converged, an instruction related to a calculation-process end is transmitted so as to end the processing flow, and when they are not converged, an instruction related to a calculation-process continuation is transmitted and Step S1 is executed. In addition, at this time point, a final result of calculation and an intermediate result thereof may be outputted to the data output unit 202.

The calculation and control unit 203 determines convergence in such cases that, in relation to the amount of transaction in a fuel transaction market being calculated in an individual period at Step S4, a cumulative value of the amount of transaction for the first time in a fuel transaction market is a predetermined determination value 1 (D1) or less, and that a cumulative value of the difference between the amount of transaction to that of the previous transaction from the second time onward in a fuel transaction market is a determination value 1 (D1) or less, and also a cumulative value of the amount of electric power-generation correction calculated in an individual period at Step S4 is a determination value 2 (D2) or less. Here, the determination value 1 (D1) and the determination value 2 (D2) are values stored in the database 205.

A convergence determination expression 1 using the determination value 1 (D1) can be expressed such as Expression 33, for example (refer to FIG. 17). A convergence determination expression 2 using the determination value 2 (D2) can be expressed such as Expression 34, for example (refer to FIG. 17). The convergence determination of the calculation and control unit 203 is not limited to this manner; convergence determination may appropriately be performed using other values. For example, it is possible for the convergence determination to use a sum-total of errors to previous values of a tank fuel unit-price, the amount of tank-fuel heat and the like. In addition, a case is conceivable in which, by setting the frequency of planning formulation processing as a reference, a review is repeatedly performed until a constant number of repetitions is reached.

At Step S11, coordination data for an electric power demand-supply plan (fourth coordination data) is formed. To be specific, in the data coordination unit 204, a tank fuel unit-price, the amount of tank-fuel heat, an lower or upper limit value of a fuel-consumption amount constraint and so on are calculated from a transaction plan in a fuel transaction market, an electric power-generation correction plan and an operational plan of fuel tank which are results calculated by the fuel demand-supply planning unit 207, and these kinds of data are transmitted to the electric power demand-supply planning unit 206.

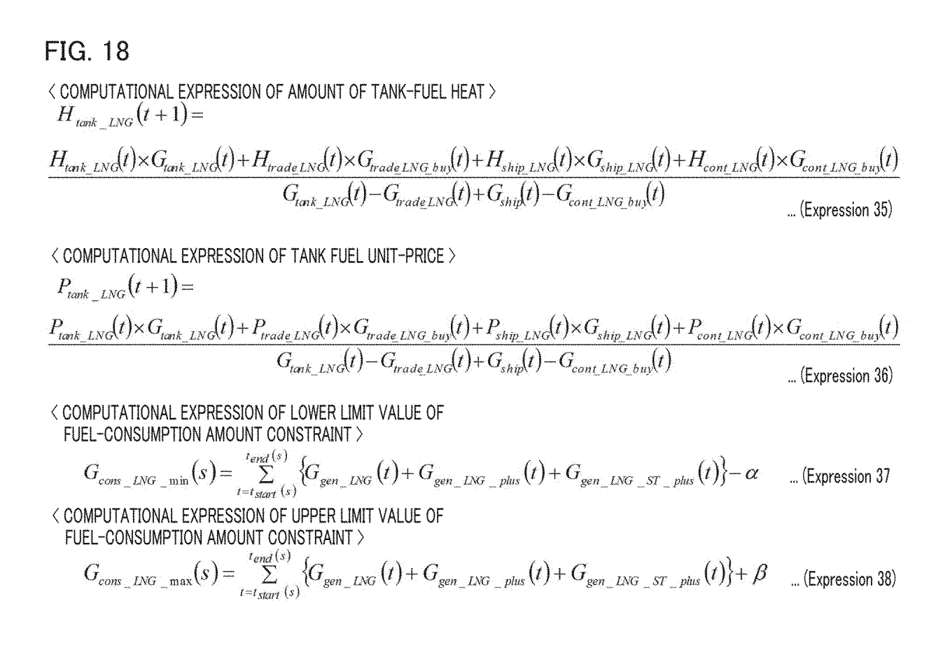

The data coordination unit 204 extracts the amount of transaction in a fuel transaction market from a transaction plan in the fuel transaction market for an individual period and extracts the volume of a tank and the amount of fuel consumption from an operational plan of fuel tank for an individual period, and, from a mutual fuel transaction amount according to a mutual fuel contract, a shipping plan, a fuel-market heat amount and an initial amount of tank-fuel heat stored in the database 205, the amount of tank-fuel heat is calculated for an individual period. The computational expression of the amount of tank-fuel heat can be expressed such as Expression 35, for example (refer to FIG. 18). However, the amount of transaction (Gtrade-LNG-buy) indicates a portion of purchase in the amount of transaction in the fuel transaction market. The amount of transaction (Gcont-LNG-buy) indicates a portion of purchase in a mutual fuel transaction amount according to a mutual fuel contract.

In addition, the amount of transaction in a fuel transaction market is extracted from a transaction plan in the fuel transaction market for an individual period, and the volume of a tank and the amount of fuel consumption are extracted from an operational plan of fuel tank for an individual period, so that, from a mutual fuel transaction amount according to a mutual fuel contract, a shipping plan, a fuel market price and an initial tank-fuel unit-price stored in the database 205, a tank fuel unit-price is calculated for an individual period. The computational expression of the tank fuel unit-price can be expressed such as Expression 36, for example (refer to FIG. 18).

Moreover, the amount of electric power-generation correction of an electric power generating facility in an individual period is extracted from an electric power-generation correction plan, and an electric power-generation correction fuel-consumption amount in an electric power generating facility is reversely calculated for an individual period from a power-generation characteristic of each of electric power generating facilities stored in the database 205, so that an electric power-generation correction fuel-consumption plan is formed. The electric power-generation correction fuel-consumption plan calculated here is added to an electric power-generation fuel-consumption plan calculated at Step S2 so as to take a fuel-consumption amount constraint. The computational expression of a lower limit value of fuel-consumption amount constraint can be expressed such as Expression 37, for example (refer to FIG. 18). The computational expression of an upper limit value of fuel-consumption amount constraint can be expressed such as Expression 38, for example (refer to FIG. 18).

As described above, in an energy demand-supply plan formulation apparatus according to the present invention which formulates a transaction plan in an electric power transaction market and an electric power generation plan therein, a steam demand-supply plan, and a fuel demand-supply plan, the energy demand-supply plan formulation apparatus comprises: a data coordination unit for calculating first coordination data including an electric power-generation unit-price and specific heat consumption from the electric power generation plan, for calculating second coordination data including an amount of fuel consumption from the steam demand-supply plan, and for calculating third coordination data including an electric power-generation fuel-consumption plan from the transaction plan and the electric power generation plan; a steam demand-supply planning unit for formulating a steam demand-supply plan by taking in first coordination data calculated by the data coordination unit; an electric power demand-supply planning unit for formulating a transaction plan in the electric power transaction market and an electric power generation plan therein by taking in second coordination data calculated by the data coordination unit; and a fuel demand-supply planning unit for formulating the fuel demand-supply plan by taking in third coordination data calculated by the data coordination unit. By taking the configuration to mutually achieve data coordination between an electric power demand-supply plan, a fuel demand-supply plan, and a steam demand-supply plan, it becomes possible to formulate a demand-supply plan including an electric power transaction and a fuel transaction, and to increase profits by considering changes in electric power generation efficiency of a thermal power generator according to its steam supply.

In addition as described above, an energy demand-supply plan formulation program and an energy demand-supply plan formulation method according to the present invention comprise: a first step for formulating a transaction plan in an electric power transaction market and an electric power generation plan therein; a second step for determining whether or not formulation of a steam demand-supply plan is required to be performed based on a transaction plan and an electric power generation plan formulated at the first step; a third step for calculating first coordination data including an electric power-generation unit-price and specific heat consumption from the electric power generation plan, when determination is performed at the second step that formulation of a steam demand-supply plan is required to be performed; a fourth step for formulating a steam demand-supply plan by taking in first coordination data calculated at the third step; a fifth step for calculating second coordination data including an amount of fuel consumption from a steam demand-supply plan formulated at the fourth step; a sixth step for formulating a transaction plan in an electric power transaction market and an electric power generation plan therein by taking in second coordination data calculated at the fifth step; a seventh step for determining whether or not formulation of a fuel demand-supply plan is required to be performed based on a transaction plan in an electric power transaction market and an electric power generation plan therein formulated at the sixth step; an eighth step for calculating third coordination data including an electric power generation fuel-consumption plan from a transaction plan in an electric power transaction market and an electric power generation plan therein formulated at the sixth step, when determination is performed at the seventh step that formulation of a fuel demand-supply plan is required to be performed; and a ninth step for formulating a fuel demand-supply plan by taking in third coordination data calculated at the eighth step.

Moreover as described above, the energy demand-supply plan formulation program and the energy demand-supply plan formulation method according to the present invention further comprise: a tenth step for determining whether or not formulation of a transaction plan in an electric power transaction market and an electric power generation plan therein, a steam demand-supply plan, and a fuel demand-supply plan is required to be repeatedly performed; and an eleventh step for calculating a fourth coordination data including a tank fuel unit-price from a fuel demand-supply plan formulated at the aforementioned ninth step, when determination is performed at the tenth step where formulation of a transaction plan in an electric power transaction market and an electric power generation plan therein, a steam demand-supply plan and a fuel demand-supply plan is required to be repeatedly performed, wherein the aforementioned first step for formulating a transaction plan in an electric power transaction market and an electric power generation plan therein is executed by taking in fourth coordination data calculated at the eleventh step.

In an energy demand-supply plan formulation apparatus which formulates an electric power demand-supply plan, a fuel demand-supply plan and a steam demand-supply plan, the energy demand-supply plan formulation apparatus comprises: a database for storing data required for an electric power demand-supply plan, a fuel demand-supply plan and a steam demand-supply plan; an electric power demand-supply planning unit for formulating a transaction plan in an electric power transaction market and an electric power generation plan therein for a thermal power generator by taking into consideration of fuel acquisition and steam supply; a fuel demand-supply planning unit for formulating a transaction plan in a fuel transaction market and an operational plan of fuel tank therein by taking into consideration of a reserve power-generating capacity and an electric power transaction; a steam demand-supply planning unit for formulating a steam demand-supply plan by taking into consideration of acquirable fuel and an achievable amount of electric power generation, an electric power transaction in an electric power transaction market and efficiency of a power generator therein; a data coordination unit for passing mutual data between the electric power demand-supply planning unit, the fuel demand-supply planning unit and the steam demand-supply planning unit; and a calculation and control unit for performing a calculation start of an energy demand-supply plan and convergence determination. By taking the configuration to include the steam demand-supply planning unit and to mutually perform data coordination between the steam demand-supply planning unit and the electric power demand-supply planning unit, profits can be increased by reflecting changes in efficiency of a thermal power generator according to its steam supply.

An energy demand-supply plan formulation program is characterized in that the computer executes: an electric power demand-supply planning process for formulating a transaction plan in an electric power transaction market and an electric power generation plan therein; a fuel demand-supply planning process for formulating a transaction plan in a fuel transaction market and an operational plan of fuel tank therein; a steam demand-supply planning process for formulating a steam demand-supply plan; a data coordination process for passing mutual data between the electric power demand-supply planning process, the fuel demand-supply planning process and the steam demand-supply planning process; and a calculation and control process for performing a calculation start of an energy demand-supply plan and convergence determination. By taking the configuration to include the steam demand-supply planning process, and to mutually perform data coordination between a steam demand-supply plan and an electric power demand-supply plan, profits can be increased by reflecting changes in efficiency of a thermal power generator according to its steam supply.

### Embodiment 2

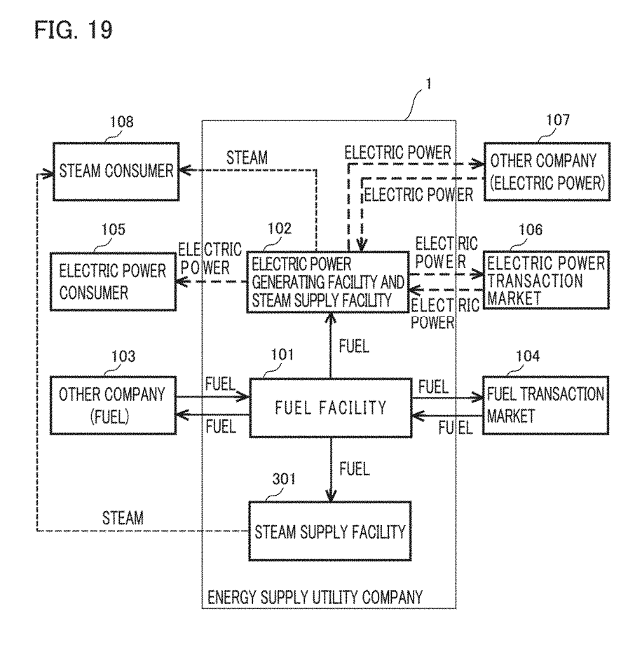

In Embodiment 1 of the present invention, an electric power generating facility and steam supply facility is presumed in which a power generator is put under consideration. In the electric power demand-supply planning unit 206, a transaction plan in an electric power transaction market and an electric power generation plan therein are formulated, and, in the steam demand-supply planning unit 208, a steam demand-supply plan is formulated. In Embodiment 2 of the present invention, a steam supply facility such as a boiler is also presumed, and so it is made possible to supply steam from the steam supply facility in place of a thermal power generator. FIG. 19 is a schematic diagram illustrating exchanges of electric power, fuel and steam in an energy supply utility company according to Embodiment 2 of the present invention.

A functional block diagram of an energy demand-supply plan formulation apparatus according to Embodiment 2 of the present invention is similar to that of the energy demand-supply plan formulation apparatus 2 in Embodiment 1. A flowchart showing the procedures of an energy demand-supply plan formulation program according to Embodiment 2 of the present invention is similar to the flowchart in Embodiment 1. The energy demand-supply plan formulation program is stored in a memory medium of a disk or the like, and the formulation of an energy demand-supply plan is executed by the computer.

At Step S4, a steam demand-supply plan is formulated in a similar manner to Embodiment 1; however, steam supply using a steam supply facility 301 is performed in addition to the steam supply by the electric power generating facility and steam supply facility 102. For this reason, in the steam demand-supply planning unit 208, an optimization problem including a computational expression, an objective function and a constraint condition is formed in advance as follows. A heat consumption characteristic of steam supply facility (fboiler-ST) is set for every one of steam supply facilities, and is a characteristic indicating the relationship between the amount of consumption heat and the amount of steam supply, so that the characteristic can be expressed by a mathematical expression, a graph and/or the like.

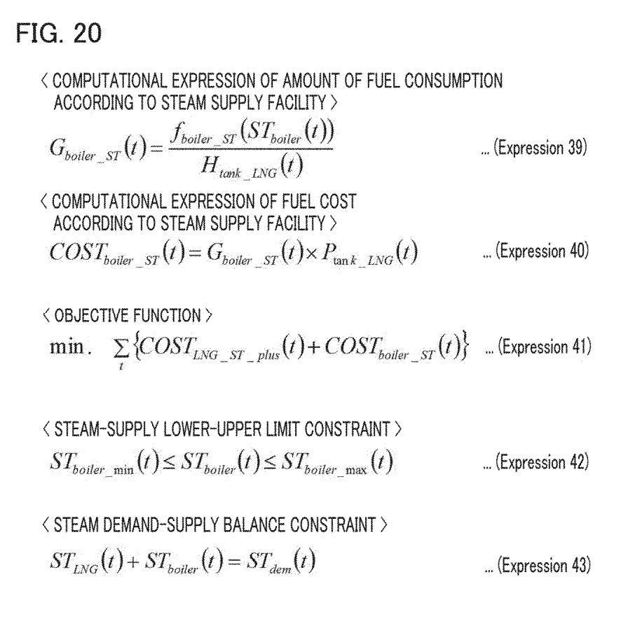

A steam-supply-amount upper-limit value of steam supply facility (STboiler-max) is an upper limit value for indicating a range in which each of steam supply facilities can supply the steam. A steam-supply-amount lower-limit value of steam supply facility (STboiler-min) is a lower limit value for indicating a range in which each of steam supply facilities can supply the steam. As computational expressions, the computational expressions are set for the amount of fuel consumption by the steam supply facility 301, and for a fuel-cost increase thereby. The computational expression of the amount of fuel consumption (Gboiler-ST) with respect to the amount of steam supply (STboiler) can be expressed by Expression 39, for example (refer to FIG. 20). A computational expression of a fuel cost (COSTboiler-ST) with respect to the amount of steam supply (STboiler) can be expressed by Expression 40, for example (refer to FIG. 20). As the objective function, an object of optimization calculation is to minimize expense according to a fuel-cost increase.

Because the steam supply facility 301 is taken into consideration in addition to Embodiment 1, the objective function can be expressed such as Expression 41, for example (refer to FIG. 20). In addition, as constraint conditions, being set are a range in which the steam supply facility can supply its steam (steam-supply lower-upper limit constraint), and a steam demand-supply balance constraint for securing the amount of steam supply required on a steam supply contract. A steam-supply lower-upper limit constraint can be expressed such as Expression 42, for example (refer to FIG. 20). A steam demand-supply balance constraint can be expressed such as Expression 43, for example (refer to FIG. 20).

As described above, the energy demand-supply plan formulation apparatus and the energy demand-supply plan formulation program according to the embodiment can formulate a steam demand-supply plan which minimizes steam supply costs by taking the steam supply by the steam supply facility 301 into consideration in the steam demand-supply planning unit 208. In Embodiment 2 in its entirety, it becomes possible to increase profits by taking supply in the steam supply facility into consideration. In the steam demand-supply planning unit, it is characterized in that the steam supply facility is taken into consideration. By taking a steam supply facility into consideration in a steam demand-supply planning unit, it is possible to formulate a steam demand-supply plan by also taking into consideration of a facility which does not supply electric power, and to increase profits by reflecting changes in efficiency of a thermal power generator according to its steam supply.

### Embodiment 3

In Embodiment 1 of the present invention, steam is required to be supplied from a power generator in order to perform steam supply. In Embodiment 2 of the present invention, steam is required to be supplied from a power generator or a boiler in order to perform steam supply. In Embodiment 3 of the present invention, an energy demand-supply plan formulation apparatus supply steam from a steam transaction market 401. It is possible to supply steam to a steam consumer by purchasing the steam in the team transaction market, so that selling the steam is enabled from an electric power generating facility and steam supply facility.

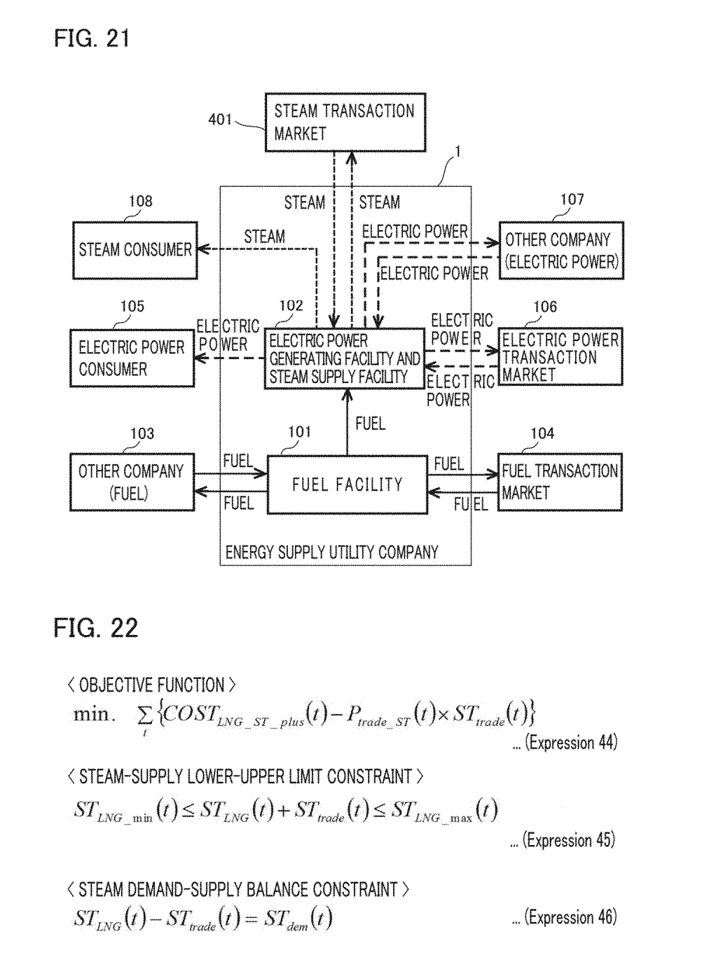

FIG. 21 is a schematic diagram illustrating exchanges of electric power, fuel and steam in an energy supply utility company according to Embodiment 3 of the present invention. A functional block diagram of the energy demand-supply plan formulation apparatus according to Embodiment 3 of the present invention is similar to that of the energy demand-supply plan formulation apparatus 2 in Embodiment 1. A flowchart showing the procedures of a program which is executed by a computer performing an energy demand-supply plan according to Embodiment 3 of the present invention is similar to the flowchart in Embodiment 1.

At Step S4, a steam demand-supply plan is formulated in a similar manner to Embodiment 1; however, a profit is calculated by including a transaction in the steam transaction market 401, in addition to the steam supply by the electric power generating facility and steam supply facility 102. For this reason, in the steam demand-supply planning unit 208, an optimization problem including a computational expression, an objective function and a constraint condition is formed in advance as follows. The amount of steam transaction (STtrade) is the amount of steam transaction in the steam transaction market; the amount of sale takes a positive value, and the amount of purchase, a negative value. A steam transaction price (Ptrade-ST) is a transaction price when a buy and a sell of steam are performed in the steam transaction market.

For example, the objective function can be expressed such as Expression 44 (refer to FIG. 22). A steam-supply lower-upper limit constraint is presumed at a sale time-point in a transaction market, and, in addition to Expression 18, by further adding a condition such as Expression 45, the sum of the amount of supply to a steam consumer and the amount of sale to the market takes within a range by a lower or upper limit value of the facility (refer to FIG. 22). In addition, a steam demand-supply balance constraint in consideration of a market transaction of steam can be expressed such as Expression 46, for example (refer to FIG. 22).

As described above, the energy demand-supply plan formulation apparatus and the energy demand-supply plan formulation program according to the embodiment can formulate a steam demand-supply plan which minimizes steam supply costs by taking the transaction in the steam transaction market 401 into consideration in the steam demand-supply planning unit 208. In Embodiment 3 in its entirety, it becomes possible to increase profits by including the balance of accounts by steam transactions. The energy demand-supply plan formulation apparatus according to the embodiment is characterized in that the steam transaction market is taken into consideration in the aforementioned steam demand-supply planning unit. By taking a steam transaction market into consideration in a steam demand-supply planning unit, it is possible to formulate a steam demand-supply plan by taking into consideration of transactions in the market, and to increase profits by reflecting changes in efficiency of a thermal power generator according to its steam supply.

### Embodiment 4

In Embodiment 1 of the present invention, an electric power generating facility and steam supply facility is presumed in which a power generator is put under consideration. In the electric power demand-supply planning unit 206, a transaction plan in an electric power transaction market and an electric power generation plan therein are formulated, and, in the steam demand-supply planning unit 208, a steam demand-supply plan is formulated. In Embodiment 4 of the present invention, it becomes possible to determine, in regard to a steam supply contract being steam demand handled by the steam demand-supply planning unit, whether or not steam supply is to be performed by taking into consideration of changes in the balance of accounts according to the steam supply. A supply contract determination unit 501 performing such determination described above is a constituent element of the energy demand-supply plan formulation apparatus 2.

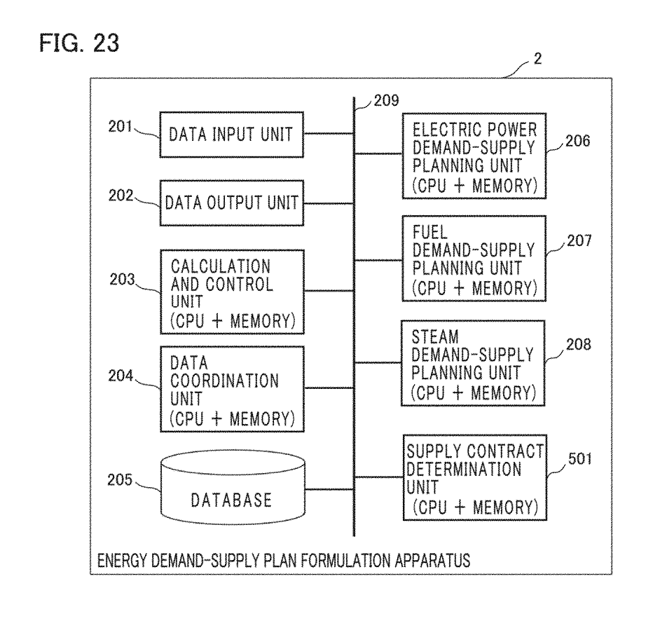

FIG. 23 is a functional block diagram illustrating the energy demand-supply plan formulation apparatus according to Embodiment 4 of the present invention. In Embodiment 4 of the present invention, it is presumed that the energy supply utility company 1 introduces the energy demand-supply plan formulation apparatus 2, and a transaction plan in an electric power transaction market and a fuel transaction market is formulated so that profits increase in an energy demand-supply plan. The energy demand-supply plan formulation apparatus 2 is constituted of the data input unit 201, the data output unit 202, the calculation and control unit 203, the data coordination unit 204, the database 205, the electric power demand-supply planning unit 206, the fuel demand-supply planning unit 207, the steam demand-supply planning unit 208, and the supply contract determination unit 501, which are interconnected by the communications means 209.

Other than the supply contract determination unit 501, those constituent items, portions or parts are equivalent or similar to those in Embodiment 1; thus, their explanation is omitted. The supply contract determination unit 501 having the function for determining whether steam supply being steam demand handled in the steam demand-supply planning unit includes a CPU and a DRAM, for example. The supply contract determination unit 501 receives an instruction from the calculation and control unit 203 after the first time processes in the electric power demand-supply planning unit 206, the fuel demand-supply planning unit 207, the steam demand-supply planning unit 208 and the data coordination unit 204, so that, from profits according to each of the plans calculated by the data coordination unit 204, a steam supply contract is signed when a profit increases according to steam supply, which is then reflected. When a profit decreases, a steam supply contract is canceled. Determination with respect to a steam supply contract is stored in the database 205.

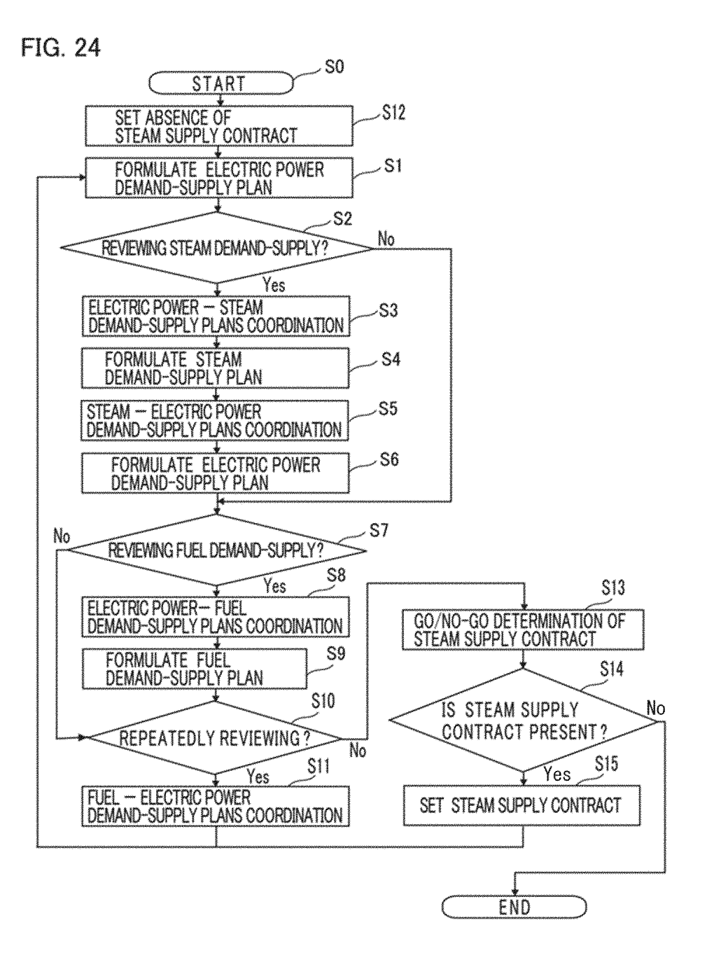

FIG. 24 is a flowchart showing the procedures of an energy demand-supply plan formulation program according to Embodiment 4 of the present invention. At Step S12, a condition is set for the absence of steam supply in order to calculate a profit when steam supply is not performed. Namely, the amount of steam supply is set to zero. In the processing from Step S1 onward, an electric power demand-supply plan and a fuel demand-supply plan are formulated. At Step S13, based on a change in a profit according to a steam supply contract, determination is performed on the contract. To be specific, in the supply contract determination unit 501, it is so arranged that, by comparing a profit in a case in which a plan is formulated under a condition of a steam supply contract being present with a profit in a case in which a plan is formulated under a condition of a steam supply contract being absent, a relevant steam supply contract is signed when a profit of a steam supply contract being present increases, but a relevant steam supply contract is canceled when the profit decreases.

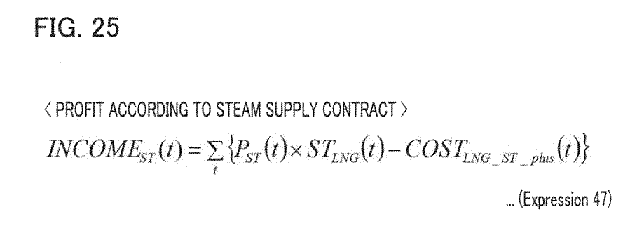

Here, a profit (INCOMEst) according to a steam supply contract can be expressed by Expression 47 (refer to FIG. 25). A supply price (Pst) on a steam supply contract is a price when steam supply is performed. At Step S14, determination is performed on the presence or absence of an unreviewed steam supply contract. When an unreviewed steam supply contract remains, the processing proceeds to Step S15, and a relevant steam supply contract is set so as to update as steam demand. Subsequently, the processing repeatedly performed from Step S1, and a plan is formulated on a condition for the presence of steam supply, so that profits are calculated.

As described above, the energy demand-supply plan formulation apparatus according to the embodiment performs, by the supply contract determination unit 501, go/no-go determination of a steam supply contract from a change in a profit according to steam supply, and can then formulate a steam demand-supply plan so as to increase profits according to the steam supply, so that it becomes possible to increase profits in total. In regard to the aforementioned steam demand-supply planning unit, it is characterized that a supply contract determination unit is included for signing a contract by determining only a steam supply contract which increases profits. By using the supply contract determination unit and only signing a steam supply contract which is effective to increase profits, a steam demand-supply plan can be formulated reliably capable of increasing profits, and the profits can be increased in total.

Furthermore as described above, the energy demand-supply plan formulation program and the energy demand-supply plan formulation method according to the present invention further comprise: a twelfth step for setting an amount of steam supply to zero; a thirteenth step for determining continuation or cancellation of a steam supply contract from a change in a profit according to a steam supply contract, when determination is performed at the aforementioned tenth step where formulation of a transaction plan in an electric power transaction market and an electric power generation plan therein, a steam demand-supply plan and a fuel demand-supply plan is not repeatedly required to be performed; a fourteenth step for determining whether or not an unreviewed steam supply contract exists; and a fifteenth step for setting a steam supply contract under review, when determination is performed that an unreviewed steam supply contract exists, wherein the twelfth step is executed before executing the aforementioned first step.

In addition, in another invention included in the embodiment described above, an energy demand-supply plan formulation apparatus formulates an electric power generation plan being a plan of the amount of electric power generation in which a power generator generates electric power, and a transaction plan being a plan of the amount of electric power to perform at least one of an electric power buy and an electric power sell in an electric power transaction market; in regard to computational expression (for example, Expression 21 including Ggen-LNG-ST-plus calculated by Expression 15) interrelating the amount of electric power generation (for example, ELNG of Expression 15) of the power generator, the amount of steam (for example, STLNG of Expression 15) supplied in the amount of electric power generation by the power generator to the exterior of the power generator, and the amount of fuel consumption (for example, Ggen-LNG′ of Expression 21 calculated by including Ggen-LNG-ST-plus calculated by Expression 15) of the power generator at a time when the power generator is at the amount of the electric power generation and at the amount of steam also supplying, or in regard to information for forming the computational expression, the energy demand-supply plan formulation apparatus comprises: a memory unit (for example, the database 205) for storing fuel-consumption-amount calculation information (for example, the function fLNG-ST of Expression 15) being an expression as in the computational expression in which an increased amount of the amount of fuel consumption (for example, Ggen-LNG-ST-plus of Expression 21) according to the amount of the supplied steam (for example, STLNG of Expression 15 for calculating Ggen-LNG-ST-plus of Expression 21) has a different characteristic depending on the amount of electric power generation (for example, ELNG of Expression 15 for calculating Ggen-LNG-ST-plus of Expression 21) of the power generator; and a demand-supply planning unit for formulating an electric power generation plan (for example, ELNG(t) of Expression 13) of the power generator and a transaction plan (for example, Etrade(t) of Expression 13) in the electric power transaction market, in accordance with an evaluation function (for example, Expression 4 including Ggen-LNG of Expression 1) based on the amount of the fuel consumption (Ggen-LNG calculated by Expression 1 recursively updated by a computational expression for Ggen-LNG′ of Expression 21) calculated on a basis of the fuel-consumption-amount calculation information, by setting as constraint conditions a constraint (for example, Expression 13) with respect to a sum-total of the amount of electric power generation generated by the power generator and the amount of the electric power exchanged in the electric power transaction market, and a constraint (for example, Expression 18 or Expression 19) with respect to the amount of the steam supplied by the power generator to the exterior of the power generator.

Note that, in the embodiment described above, an electric power generation plan and a transaction plan are formulated in accordance with the same first evaluation function (for example, Expression 4); a steam demand-supply plan being a plan of the amount of steam supplied from a power generator is formulated in accordance with the other second evaluation function (for example, Expression 17) based on an electric power generation plan (for example, ELNG(t) of Expression 15) as an evaluation result; and, based on a steam demand-supply plan (for example, STLNG(t) of Expression 15 that minimizes Expression 17) as an evaluation result, the first evaluation function is updated (for example, Expression 1 for calculating Ggen-LNG of Expression 4 is updated), so that an electric power generation plan and a transaction plan are re-formulated. However, those electric power generation plan, transaction plan and steam demand-supply plan may be collectively formulated from one evaluation function. For example, by storing or forming in advance an expression for calculating the amount of fuel consumption of a power generator from the amount of electric power generation and the amount of steam, an electric power generation plan, a transaction plan and a steam demand-supply plan may be collectively formulated in accordance with one evaluation function including a sum-total of fuel costs calculated accordingly, and electric power purchase costs and/or electric power sales costs in an electric power transaction market. As also for this computational expression, when it is presumed that an increased amount of the amount of fuel consumption according to the amount of steam supplied by a power generator has a different characteristic depending on the amount of electric power generation of the power generator, it is possible to formulate an electric power generation plan, a transaction plan and a steam demand-supply plan which take into consideration of changes in electric power generation efficiency of the power generator according to its steam supply. Here, the increased amount of the amount of fuel consumption according to the amount of steam supplied by a power generator means the amount of fuel consumption which is additionally required in order to obtain an additional amount of steam from the power generator while maintaining the amount of electric power generation, with respect to the amount of fuel consumption required to obtain the amount of electric power generation, when the amount of steam supplied by the power generator is zero, for example. In many cases, a power generator has a characteristic in which the increased amount changes depending on the amount of electric power generation, and so, by using the expression including a characteristic of such a power generator, and by formulating an electric power generation plan, a transaction plan and a steam demand-supply plan, those plans can be formulated to have large profits.

In addition, as the power generator, a plurality of power generators may be used where the aforementioned characteristic differs to each other. Those power generators supply electric power and/or steam generated by themselves to a mutually common utility company, or consumer. Electric power bought in an electric power transaction market can also be similarly supplied to those utility companies or consumers. In those cases, it may be adopted that a computational expression having the aforementioned characteristic of a power generator for individual one of the plurality of power generators is stored or formed in advance, and in accordance with an evaluation function (for example, the sum-total is included in Expression 4 and Expression 17) including a sum-total of fuel costs derived from the expression for an individual power generator, an electric power generation plan and a steam demand-supply plan are formulated for individual one of those power generators. Moreover, when there is only one power generator which can supply steam therefrom and its amount of the steam to be supplied is determined by a contract, the steam demand-supply plan may be determined in advance.

As [Claim 10] the Amount

Furthermore, in the embodiment described above, an evaluation function (for example, Expression 4) for formulating an electric power generation plan and a transaction plan is formed based on a steam demand-supply plan (for example, STLNG(t) of Expression 15) being a plan of the amount of steam supplied from the power generator and on the aforementioned fuel-consumption-amount calculation information (for example, the function fLNG-ST of Expression 15), and is calculated in accordance with a characteristic expression (for example, Expression 1 updated by Expression 21 in accordance with Expression 15) being a relational expression between the amount of electric power generation of the power generator and the amount of fuel consumption thereof, where the characteristic expression does not include the amount of steam of the power generator as a parameter. In a characteristic expression of a power generator which takes into consideration of changes in electric power generation efficiency of the power generator according to the steam supply described above, it is additionally made possible to further implement the function for also coping with a steam demand-supply plan, by intermediately forming a characteristic expression which does not include the amount of the aforementioned steam as a parameter, with respect to a design of a conventional energy demand-supply plan formulation apparatus which has the function of formulating an electric power generation plan and a transaction plan but does not cope with a steam supply plan. For example, with respect to a program in which an electric power generation plan and a transaction plan are formulated using a characteristic expression of a power generator, but a steam demand-supply plan is not formulated nor considered, it is possible to output, from the program, an electric power generation plan and a transaction plan taking steam supply into consideration by handling, as a substitution to the characteristic expression, the aforementioned characteristic expression intermediately formed in consideration of the steam supply.

Note that, in the present invention, the embodiments each can be freely combined, and/or each of the embodiments can be appropriately modified or eliminated without departing from the scope of the invention.

### EXPLANATION OF NUMERALS AND SYMBOLS

Numeral “1” designates an energy supply utility company; “2,” energy demand-supply plan formulation apparatus; “101,” fuel facility; “102,” electric power generating facility and steam supply facility; “103,” other company (fuel); “104,” fuel transaction market; “105,” electric power consumer; “106,” electric power transaction market; “107,” other company (electric power); “108,” steam consumer; “201,” data input unit; “202,” data output unit; “203,” calculation and control unit; “204,” data coordination unit; “205,” database; “206,” electric power demand-supply planning unit; “207,” fuel demand-supply planning unit; “208,” steam demand-supply planning unit; “209,” communications means; “301,” steam supply facility; “401,” steam transaction market; and “501,” supply contract determination unit.

What is claimed is:

1. An energy demand-supply plan formulation apparatus which formulates a transaction plan in an electric power transaction market and an electric power generation plan therein, a steam demand-supply plan, and a fuel demand-supply plan, the energy demand-supply plan formulation apparatus, comprising:
a data coordination unit for calculating first coordination data including an electric power-generation unit-price and specific heat consumption from the electric power generation plan, for calculating second coordination data including an amount of fuel consumption from the steam demand-supply plan, and for calculating third coordination data including an electric power-generation fuel-consumption plan from the transaction plan and the electric power generation plan;
a steam demand-supply planning unit for formulating a steam demand-supply plan by taking in first coordination data calculated by the data coordination unit;
an electric power demand-supply planning unit for formulating a transaction plan in the electric power transaction market and an electric power generation plan therein by taking in second coordination data calculated by the data coordination unit; and
a fuel demand-supply planning unit for formulating the fuel demand-supply plan by taking in third coordination data calculated by the data coordination unit.

2. The energy demand-supply plan formulation apparatus as set forth in claim 1, wherein the steam demand-supply planning unit formulates a steam demand-supply plan by taking into consideration of a steam supply facility including a boiler.

3. The energy demand-supply plan formulation apparatus as set forth in claim 1, wherein the steam demand-supply planning unit formulates a steam demand-supply plan by taking into consideration of a steam transaction market.

4. The energy demand-supply plan formulation apparatus as set forth in claim 1, further comprising a supply contract determination unit for determining whether or not a profit increases according to steam supply, from a profit in a transaction plan in an electric power transaction market and an electric power generation plan therein, a steam demand-supply plan, and a fuel demand-supply plan.

5. The energy demand-supply plan formulation apparatus as set forth in claim 1, wherein, when determination is performed that formulation of a transaction plan in an electric power transaction market and an electric power generation plan therein, a steam demand-supply plan, and a fuel demand-supply plan is repeatedly required to be performed, the data coordination unit calculates a fourth coordination data including a tank fuel unit-price from the fuel demand-supply plan.

6. A non-transitory computer readable medium storing an energy demand-supply plan formulation program, comprising:
a first step for formulating a transaction plan in an electric power transaction market and an electric power generation plan therein;
a second step for determining whether or not formulation of a steam demand-supply plan is required to be performed based on a transaction plan and an electric power generation plan formulated at the first step;
a third step for calculating first coordination data including an electric power-generation unit-price and specific heat consumption from the electric power generation plan, when determination is performed at the second step that formulation of a steam demand-supply plan is required to be performed;
a fourth step for formulating a steam demand-supply plan by taking in first coordination data calculated at the third step;
a fifth step for calculating second coordination data including an amount of fuel consumption from a steam demand-supply plan formulated at the fourth step;
a sixth step for formulating a transaction plan in an electric power transaction market and an electric power generation plan therein by taking in second coordination data calculated at the fifth step;
a seventh step for determining whether or not formulation of a fuel demand-supply plan is required to be performed based on a transaction plan in an electric power transaction market and an electric power generation plan therein formulated at the sixth step;
an eighth step for calculating third coordination data including an electric power-generation fuel-consumption plan from a transaction plan in an electric power transaction market and an electric power generation plan therein formulated at the sixth step, when determination is performed at the seventh step that formulation of a fuel demand-supply plan is required to be performed; and
a ninth step for formulating a fuel demand-supply plan by taking in third coordination data calculated at the eighth step.

7. The non-transitory computer readable medium storing the energy demand-supply plan formulation program as set forth in claim 6, further comprising
a tenth step for determining whether or not formulation of a transaction plan in an electric power transaction market and an electric power generation plan therein, a steam demand-supply plan, and a fuel demand-supply plan is required to be repeatedly performed; and
an eleventh step for calculating a fourth coordination data including a tank fuel unit-price from a fuel demand-supply plan formulated at the ninth step, when determination is performed at the tenth step where formulation of a transaction plan in an electric power transaction market and an electric power generation plan therein, a steam demand-supply plan and a fuel demand-supply plan is required to be repeatedly performed, wherein
the first step for formulating a transaction plan in an electric power transaction market and an electric power generation plan therein is executed by taking in fourth coordination data calculated at the eleventh step.

8. The non-transitory computer readable medium storing the energy demand-supply plan formulation program as set forth in claim 7, further comprising
a twelfth step for setting an amount of steam supply to zero;
a thirteenth step for determining continuation or cancellation of a steam supply contract from a change in a profit according to a steam supply contract, when determination is performed at the tenth step where formulation of a transaction plan in an electric power transaction market and an electric power generation plan therein, a steam demand-supply plan and a fuel demand-supply plan is not repeatedly required to be performed;
a fourteenth step for determining whether or not an unreviewed steam supply contract exists; and
a fifteenth step for setting a steam supply contract under review, when determination is performed that an unreviewed steam supply contract exists, wherein
the twelfth step is executed before executing the first step.

9. An energy demand-supply plan formulation apparatus which formulates an electric power generation plan being a plan of an amount of electric power generation generated by a power generator, and a transaction plan being a plan of an amount of electric power to perform at least one of an electric power buy and an electric power sell in an electric power transaction market, the energy demand-supply plan formulation apparatus, comprising:
a memory unit for storing fuel-consumption-amount calculation information being an expression as in the computational expression in which an amount of increase in an amount of the fuel consumption according to an amount of the supplied steam has a different characteristic depending on an amount of electric power generation by the power generator, in a computational expression interrelating to an amount of electric power generation of the power generator, to an amount of steam supplied by the power generator to an exterior of the power generator in an amount of electric power generation thereby, and to an amount of fuel consumption by the power generator at a time when the power generator is at an amount of the electric power generation and also at an amount of the supplied steam, or in information for forming the computational expression; and
a demand-supply planning unit for formulating an electric power generation plan of the power generator and a transaction plan in the electric power transaction market, in accordance with an evaluation function based on an amount of the fuel consumption calculated on a basis of the fuel-consumption-amount calculation information, by setting as constraint conditions a constraint with respect to a sum-total of an amount of electric power generation generated by the power generator and an amount of the electric power exchanged in the electric power transaction market, and a constraint with respect to an amount of the steam supplied by the power generator to an exterior of the power generator.

10. The energy demand-supply plan formulation apparatus as set forth in claim 9, wherein the evaluation function is formed based on a steam demand-supply plan being a plan of an amount of steam supplied from the power generator and the fuel-consumption-amount calculation information, and is calculated in accordance with a characteristic expression of the power generator which is a relational expression between an amount of electric power generation by the power generator and an amount of fuel consumption of the power generator, and does not include an amount of the steam as a parameter.
